(19) United States
(12) Patent Application Publication
(10) Pub. No.: US 2026/0080103 A1
(43) Pub. Date: Mar. 19, 2026

(54) STORAGE SYSTEM INCLUDING HOST DEVICE AND STORAGE DEVICE, OPERATION METHOD THEREOF AND OPERATION METHOD OF STORAGE DEVICE

(71) Applicant: Samsung Electronics Co., Ltd., Suwon-si (KR)

(72) Inventors: Seunghoon KANG, Suwon-si (KR); Yejun JEONG, Suwon-si (KR); Dongbin PARK, Suwon-si (KR); Mingon SHIN, Suwon-si (KR); Gwangbae CHOI, Suwon-si (KR); Byungchan CHOI, Suwon-si (KR)

(73) Assignee: Samsung Electronics Co., Ltd., Suwon-si (KR)

(21) Appl. No.: 19/229,465

(22) Filed: Jun. 5, 2025

(30) Foreign Application Priority Data
Sep. 19, 2024 (KR) 10-2024-0126655

(51) Int. Cl. G06F 21/64; G06F 21/79

(52) U.S. Cl. CPC G06F 21/64; G06F 21/79

(57) ABSTRACT

An operation method of a storage device includes receiving first and second write data from an external host device, the first and second write data among a plurality of write data included in a first chunk, generating first verification sub-hash data and second verification sub-hash data respectively corresponding to the first write data and the second write data, updating an integrity hash map by storing the first verification sub-hash data and the second verification sub-hash data in the integrity hash map, and performing data integrity verification for the plurality of write data, based on the integrity hash map completed. The storage device includes a buffer memory configured to store the integrity hash map and having a storage capacity smaller than a data size of the first chunk.

### CROSS-REFERENCE TO RELATED APPLICATIONS

This application claims priority under 35 U.S.C. § 119 to Korean Patent Application No. 10-2024-0126655 filed on Sep. 19, 2024, in the Korean Intellectual Property Office, the disclosures of which are incorporated by reference herein in their entireties.

### BACKGROUND

Some example embodiments described herein relate to a semiconductor memory, and more particularly, relate to a storage system including a host device and a storage device, an operation method thereof, and/or an operation method of the storage device.

A semiconductor memory may be classified as a volatile memory, which loses data stored therein when a power is turned off and may include memory such as a static random access memory (SRAM) and/or a dynamic random access memory (DRAM). Alternatively a semiconductor memory may be classified as a nonvolatile memory, which retains data stored therein even when a power is turned off, and may include memory such as one or more of a flash memory, a phase-change RAM (PRAM), a magnetic RAM (MRAM), a resistive RAM (RRAM), or a ferroelectric RAM (FRAM).

A flash memory is being widely used as a high-capacity storage medium. A storage device refers to a device, which stores data under control of a host device, such as a computer, a smartphone, or a smart pad. The storage device includes a device which stores data on a magnetic disk, such as a hard disk drive (HDD), or a device which stores data in a semiconductor memory, in particular, a nonvolatile memory, such as a solid state drive (SSD) or a memory card.

With the development of semiconductor fabrication technologies, the capacity of data which are sent to the storage device from a host device such as from a computer, a smartphone, or a smart pad is increasing. In this case, a storage capacity of a buffer memory included in the storage device and provided for data integrity verification or data integrity checking of data received from the host device may be insufficient. Accordingly, there is a desire on a storage device which performs data integrity verification by using a buffer memory with a small storage capacity.

### SUMMARY

Some example embodiments may provide a storage system including a host device and a storage device and providing improved performance, an operation method thereof, and an operation method of the storage device.

According to some example embodiments, an operation method of a storage device includes receiving first and second write data from an external device, the first and second write data among a plurality of write data included in a first chunk, generating first verification sub-hash data and second verification sub-hash data respectively corresponding to the first write data and the second write data, updating an integrity hash map by storing the first verification sub-hash data and the second verification sub-hash data in the integrity hash map, and performing data integrity verification for the plurality of write data, based on a completion of the integrity hash map updating. The storage device includes a buffer memory configured to store the integrity hash map and having a storage capacity smaller than a data size of the first chunk.

Alternatively or additionally according to some example embodiments, a storage system includes a host device and a storage device. The host device is configured to generate a plurality of host sub-hash data respectively corresponding to a plurality of write data included in a first chunk, generate host hash data based on the plurality of host sub-hash data, generate signature data based on the host hash data, and send the plurality of write data and the signature data to the storage device. The storage device is configured to generate an integrity hash map corresponding to the first chunk and based on the plurality of write data, and perform data integrity verification for the plurality of write data based on the integrity hash map being completed and on the signature data.

Alternatively or additionally according to some example embodiments, an operation method of a storage system which includes a host device and a storage device includes generating, by the host device, a plurality of host sub-hash data respectively corresponding to a plurality of write data included in a first chunk, generating, by the host device, signature data based on the plurality of host sub-hash data, sending, by the host device and to the storage device, first write data and second write data among the plurality of write data, generating, by the storage device, first verification sub-hash data and second verification sub-hash data respectively corresponding to the first write data and the second write data, updating, by the storage device, an integrity hash map by storing the first verification sub-hash data and the second verification sub-hash data in the integrity hash map, and performing, by the storage device, data integrity verification for the plurality of write data, based on the integrity hash map completed. The storage device includes a buffer memory storing the integrity hash map and having a storage capacity smaller than a data size of the first chunk.

### BRIEF DESCRIPTION OF THE FIGURES

The above and other objects and features of inventive concepts will become apparent by describing in detail some example embodiments thereof with reference to the accompanying drawings.

FIG. 1 is a block diagram illustrating a storage system according to some example embodiments.

FIG. 2 is a block diagram for describing a storage controller of FIG. 1.

FIG. 3 is a diagram for describing an example of an operation of a storage system of FIG. 1.

FIG. 4 is a flowchart for describing an operation method of a host device of FIG. 1.

FIG. 5A is a diagram for describing operation S110 to operation S130 of FIG. 4.

FIG. 5B is a diagram for describing operation S140 of FIG. 4.

FIG. 6A is a flowchart for describing an operation method of a storage device of FIG. 1.

FIG. 6B is a diagram for describing an operation of a storage device of FIG. 1.

FIG. 7 is a flowchart for describing operation S220 of FIG. 6A in detail.

FIG. 8 is a flowchart for describing operation S230 of FIG. 6A in detail.

FIG. 9 is a flowchart for describing operation S240 of FIG. 6A in detail.

FIG. 10 is a flowchart for describing an operation method of a storage device of FIG. 1 when a power-off situation occurs.

FIG. 11 is a diagram for describing an operation of a storage device of FIG. 1 when a power-off situation occurs.

FIG. 12 is a block diagram for describing a storage device of FIG. 1 in detail.

FIG. 13 is a flowchart for describing an operation method of a storage device of FIG. 1 when a power-off situation occurs.

FIG. 14 is a block diagram for describing a storage integrity manager of FIG. 1.

FIG. 15A is a diagram for describing an example of an operation of a storage device of FIG. 1 when data integrity verification is failed.

FIG. 15B is a flowchart for describing an example of an operation method of a storage device of FIG. 1 when data integrity verification is failed.

FIG. 16A is a diagram for describing another example of an operation of a storage device of FIG. 1 when data integrity verification is failed.

FIG. 16B is a flowchart for describing another example of an operation method of a storage device of FIG. 1 when data integrity verification is failed.

FIG. 17 is a flowchart for describing an operation of a storage system of FIG. 1.

FIG. 18 is a diagram for describing an example of an operation of a storage system of FIG. 1.

FIG. 19 is a diagram illustrating a data center to which a storage system according to some example embodiments is applied.

### DETAILED DESCRIPTION

Below, some example embodiments will be described in detail and clearly to such an extent that one skilled in the art easily carries out inventive concepts.

In the specification, function blocks of drawings, which respectively correspond to the terms “block”, “unit”, “logic”, etc., may be implemented in the form of software, hardware, or a combination thereof.

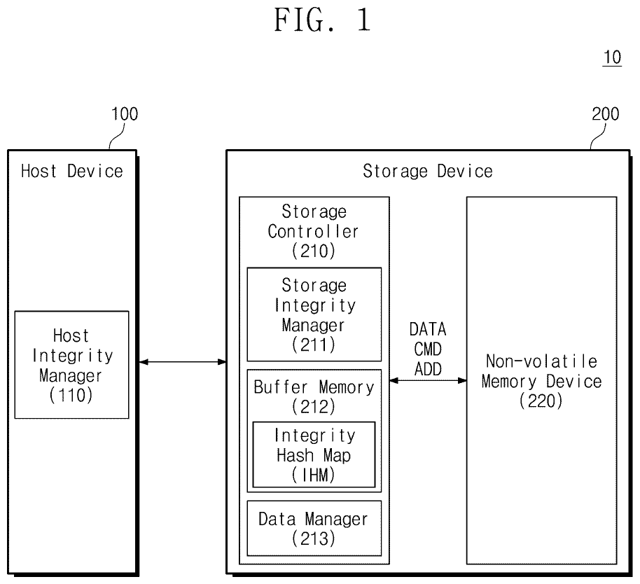

FIG. 1 is a block diagram illustrating a storage system according to some example embodiments. Referring to FIG. 1, a storage system 10 may include an external device such as a host device 100 and a storage device 200. In an some example, the storage system 10 may refer to a computing system, which is configured to process a variety of information, and may include one or more devices such as one or more of a personal computer (PC), a notebook, a laptop, a server, a workstation, a tablet PC, or a smartphone.

The host device 100 may be configured to control the storage device 200. For example, based on a given interface, the host device 100 may store data in the storage device 200 and/or may read data stored in the storage device 200. In some example embodiments, the given interface may include at least one of various interfaces such as an ATA (Advanced Technology Attachment) interface, an SATA (Serial ATA) interface, an e-SATA (external SATA) interface, an SCSI (Small Computer Small Interface) interface, an SAS (Serial Attached SCSI) interface, a PCI (Peripheral Component Interconnection) interface, a PCIe (PCI express) interface, an NVMe (NVM express) interface, an IEEE 1394 interface, an USB (Universal Serial Bus) interface, an SD (Secure Digital) card interface, an MMC (Multi-Media Card) interface, an eMMC (embedded Multi-Media Card) interface, an eUFS (embedded Universal Flash Storage) interface, a CF (Compact Flash) card interface, a CXL (Compute eXpress Link) interface, and a UFS (Universal Flash Storage) interface.

The host device 100 may include a host integrity manager 110. The host integrity manager 110 may generate host hash data based on a plurality of write data to be sent to the storage device 200 from the host device 100. For example, based on a plurality of write data included in a first chunk, the host device 100 may generate host hash data corresponding to the first chunk. The host integrity manager 110 may generate signature data based on the host hash data. Accordingly, the signature data may correspond to the first chunk. The host device 100 may send the plurality of write data of the first chunk and the signature data corresponding to the first chunk to the storage device 200.

The storage device 200 may include a storage controller 210 and a non-volatile memory device 220. In response to a request from the host device 100, the storage controller 210 may store data “DATA” (e.g., write data received from the host device 100) in the non-volatile memory device 220, and/or may send the data “DATA” stored in the non-volatile memory device 220 to the host device 100. The storage controller 210 may send a command CMD and an address ADD to the non-volatile memory device 220 to store the data “DATA” in the non-volatile memory device 220 or to read the data “DATA” stored in the non-volatile memory device 220.

Under control of the storage controller 210, the non-volatile memory device 220 may store the data “DATA” and/or may transfer the stored data “DATA” to the storage controller 210. In some example embodiments, the non-volatile memory device 220 may be a NAND flash memory device, but the present disclosure is not limited thereto. In some example embodiments, the non-volatile memory device 220 may include a memory cell array configured to store the data “DATA”. For example, the memory cell array may include a plurality of memory cells. In some examples, each of the plurality of memory cells may be or may include FLASH memory cells, such as at least one of single-level cells, multi-level cells, or triple-level cells; example embodiments are not limited thereto.

In some example embodiments, the storage controller 210 may include a storage integrity manager 211, a buffer memory 212, and a data manager 213. The storage integrity manager 211 may generate an integrity hash map IHM based on the write data received from the host device 100.

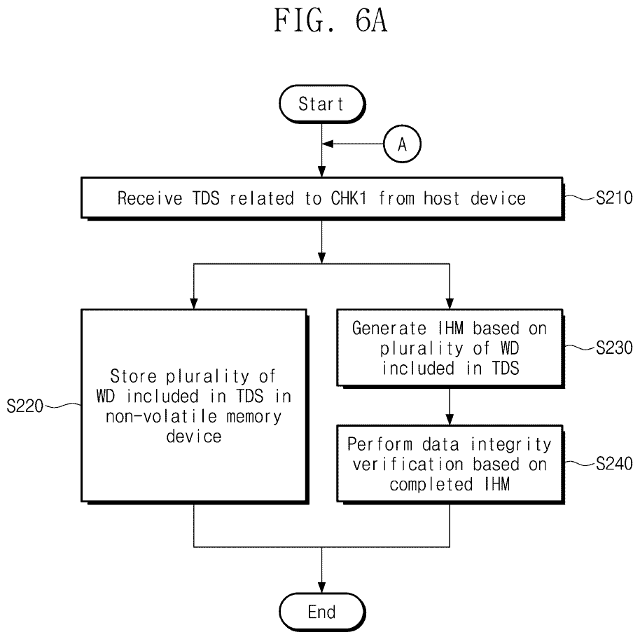

For example, the storage device 200 may receive the plurality of write data included in the first chunk and the signature data corresponding to the first chunk from the host device 100. In this case, the storage integrity manager 211 may generate the integrity hash map IHM corresponding to the first chunk, based on the plurality of write data. After the generation of the integrity hash map IHM is completed, the storage integrity manager 211 may perform data integrity checking or data integrity verification for the plurality of write data, based on the completed integrity hash map IHM and the signature data. Operations related to the data integrity verification of the storage integrity manager 211 will be described in more detail with reference to FIGS. 6B, 8, and 9.

The buffer memory 212 may be configured to store a variety of information necessary for the storage controller 210 to operate. For example, the buffer memory 212 may temporarily store data to be stored in the non-volatile memory device 220 or data read from the non-volatile memory device 220. In some example embodiments, the buffer memory 212 may store the integrity hash map IHM. For example, the buffer memory 212 may be implemented with one or more of a static random access memory (SRAM), a dynamic random access memory (DRAM), etc. The buffer memory 212 may operate at a faster read and/or write speed than that of the non-volatile memory device 220; example embodiments are not limited thereto.

The data manager 213 may manage the write data received from the host device 100 and/or the data read from the non-volatile memory device 220. In some example embodiments, the data manager 213 may store the plurality of write data included in the first chunk, which are received from the host device 100, in the non-volatile memory device 220. In some example embodiments, the data manager 213 may store the plurality of write data received from the host device 100 in the memory cell array of the non-volatile memory device 220. Meanwhile, the data manager 213 may store, in the buffer memory 212, only the write data being currently used for the update of the integrity hash map IHM from among the plurality of write data of the first chunk.

For example, unlike the above description, the storage device 200 may perform the data integrity verification for the write data of the first chunk received from the host device 100 without generating the integrity hash map IHM. In this case, for the data integrity verification, the storage device 200 should store all the write data of the first chunk in the buffer memory 212. Accordingly, the buffer memory 212 should have a storage capacity larger than a data size of the first chunk. According to the above description, costs necessary to manufacture the storage device 200 may increase.

In contrast, as described above, the storage device 200 according to some example embodiments may perform the data integrity verification or checking for the write data received from the host device 100 based on the integrity hash map IHM. To perform the data integrity verification for the write data, the storage device 200 may store, in the buffer memory 212, the integrity hash map IHM whose size is smaller than the data size of the first chunk. Alternatively or additionally, the storage device 200 may not store, in the buffer memory 212, the remaining write data among the plurality of write data of the first chunk other than the write data being currently used to update the integrity hash map IHM. For example, the buffer memory 212 may have a storage capacity smaller than the data size of the first chunk. Accordingly, a storage device with improved performance, a storage system including the storage device, and/or an operation method thereof may be provided.

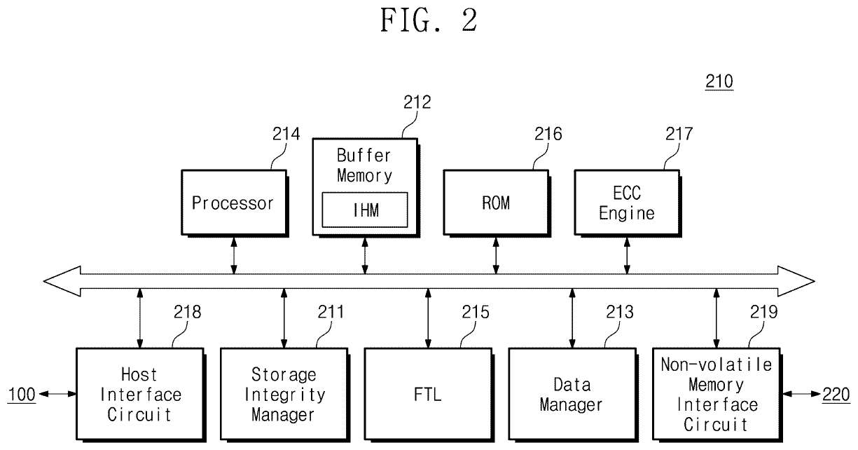

FIG. 2 is a block diagram for describing a storage controller of FIG. 1. Referring to FIG. 2, the storage controller 210 may include the storage integrity manager 211, the buffer memory 212, the data manager 213, a processor 214, a flash translation layer (FTL) 215, a read only memory (ROM) 216, an error correction code (ECC) engine 217, a host interface circuit 218, and a non-volatile memory interface circuit 219.

The storage integrity manager 211, the buffer memory 212, the data manager 213, the processor 214, the FTL 215, the ROM 216, the ECC engine 217, the host interface circuit 218, and the non-volatile memory interface circuit 219 may be connected to each other through a bus, such as a wired bus and/or a wireless buss.

The storage integrity manager 211, the buffer memory 212, and the data manager 213 are described with reference to FIG. 1, and thus, additional description will be omitted to avoid redundancy.

The processor 214 may control some or all the operations of the storage controller 210. For example, the processor 214 may execute an operating system or firmware for driving the storage controller 210. The processor 214 may generate the address ADD and the command CMD for controlling the non-volatile memory device 220, based on a request of the host device 100.

The FTL 215 may perform a role of mapping a logical address received from the host device 100 to a physical address used in the non-volatile memory device 220. In some example embodiments, the FTL 215 may perform the reliability management operations for the non-volatile memory device 220.

The ROM 216 may be used as a read only memory which stores information necessary or used in the operation of the storage controller 210. For example, the ROM 216 may be used as a portion of a firmware memory.

The ECC engine 217 may detect and correct an error of data read from the non-volatile memory device 220. For example, the ECC engine 217 may have an error correction capability of a given level. The ECC engine 217 may correct an error of data not exceeding the error correction capability and may treat data whose error level (e.g., of which the number of flipped bits) exceeds the error correction capability as an uncorrectable error.

The storage controller 210 may communicate with the host device 100 through the host interface circuit 218. The host interface circuit 218 may provide a host interface layer (HIL). In some example embodiments, the host interface circuit 218 may be implemented based on at least one of various interfaces such as a serial ATA (SATA) interface, a peripheral component interconnect express (PCIe) interface, a serial attached SCSI (SAS), a non-volatile memory express (NVMe) interface, and a universal flash storage (UFS) interface.

The storage controller 210 may communicate with the non-volatile memory device 220 through the non-volatile memory interface circuit 219. In some embodiments, the non-volatile memory interface circuit 219 may be implemented based on the NAND interface.

In some example embodiments, the storage integrity manager 211 and the data manager 213 may be implemented by hardware, software, or a combination of hardware and software. For example, at least part of the storage integrity manager 211 and the data manager 213 may be included in the storage controller 210 in the form of a separate circuit, a separate device, or a separate chip. Alternatively, at least part of the storage integrity manager 211 and the data manager 213 may be stored in the non-volatile memory device 220 in the form of an instruction or may be implemented with a software module to be loaded to the buffer memory 212 by the processor 214.

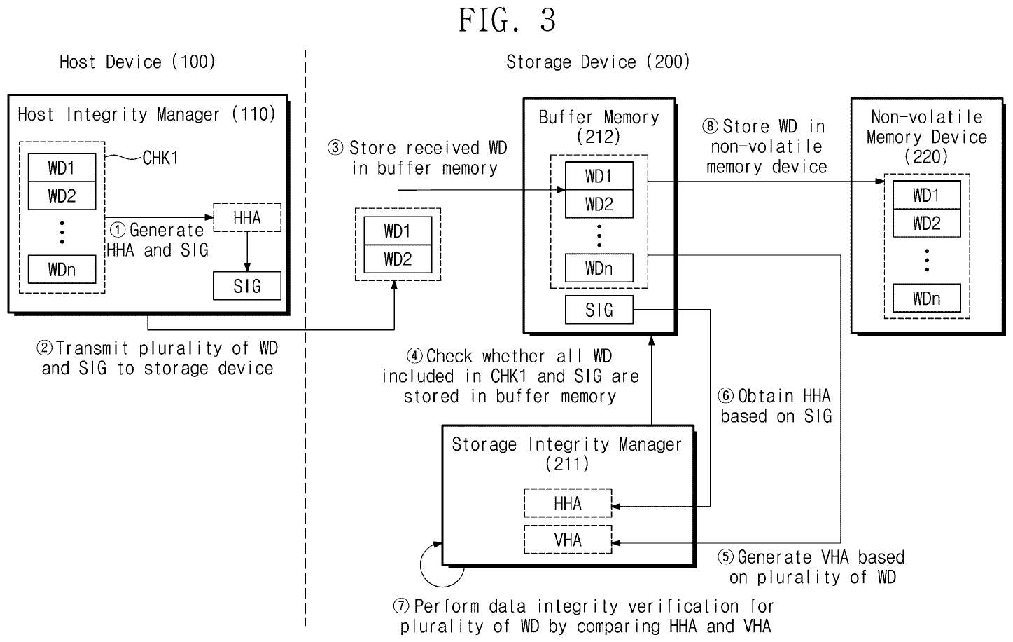

FIG. 3 is a diagram for describing an example of an operation of a storage system of FIG. 1. Referring to FIG. 3, in a first operation \textcircled{1}, the host integrity manager 110 may generate host hash data HHA based on a first chunk CHK1. Also, the host integrity manager 110 may generate signature data SIG based on the host hash data HHA.

For example, the host integrity manager 110 may apply a hash function such as but not limited to a secure hash function such as SHA-2 to the first chunk CHK1 to generate the host hash data HHA. For example, the host integrity manager 110 may apply the hash function to all the write data WD1 to WDn included in the first chunk CHK1 to generate the host hash data HHA. The host integrity manager 110 may encrypt the host hash data HHA to generate the signature data SIG. For example, the signature data SIG may be a result of encrypting the host hash data HHA with a signature key.

The chunk may refer to a series of data sets. For example, the host device 100 may send the software to the storage device 200. In this case, the software may be composed of a plurality of chunks including the first chunk CHK1. Each of the plurality of chunks may include a plurality of write data.

In a second operation \textcircled{2}, the host device 100 may send the plurality of write data WD1 to WDn included in the first chunk CHK1 and the signature data SIG to the storage device 200. For example, the host device 100 may separate or partition the plurality of write data WD1 to WDn included in the first chunk CHK1 by a given unit, so as to be sent to the storage device 200. For example, the host device 100 may separate the write data WD1 to WDn included in the first chunk CHK1 in units of two data, so as to be sent to the storage device 200.

In a third operation \textcircled{3}, the storage device 200 may store the plurality of write data received from the host device 100 in the buffer memory 212. For example, the storage device 200 may receive the first write data WD1 and the second write data WD2 from the host device 100 and may store the first write data WD1 and the second write data WD2 in the buffer memory 212.

In a fourth operation \textcircled{4}, the storage device 200 may check whether all the write data WD1 to WDn of the first chunk CHK1 are stored in the buffer memory 212 (e.g., whether all the write data WD1 to WDn of the first chunk CHK1 are received from the host device 100). In some example embodiments, the storage device 200 may check whether the signature data SIG corresponding to the first chunk CHK1 are stored in the buffer memory 212 (e.g., whether the signature data SIG corresponding to the first chunk CHK1 are received from the host device 100).

When both the signature data SIG corresponding to the first chunk CHK1 and the write data WD1 to WDn of the first chunk CHK1 are stored in the buffer memory 212, in a fifth operation \textcircled{5}, the storage device 200 may generate verification hash data VHA based on the plurality of write data WD1 to WDn stored in the buffer memory 212. For example, the storage integrity manager 211 may apply the hash function to all the write data WD1 to WDn stored in the buffer memory 212 to generate the verification hash data VHA. Accordingly, the verification hash data VHA may correspond to or fingerprint the first chunk CHK1. In some example embodiments, the hash function may be the same as the hash function used for the host integrity manager 110 to generate the host hash data HHA.

In a sixth operation \textcircled{6}, the storage device 200 may decrypt the signature data SIG to obtain the host hash data HHA. For example, the storage integrity manager 211 may decrypt the signature data SIG based on the signature key and may obtain the host hash data HHA.

For example, the host device 100 and the storage device 200 may share the signature key which is used to generate the signature data SIG (e.g., to encrypt the host hash data HHA) and/or to decrypt the signature data SIG (e.g., to obtain the host hash data HHA). The encryption and/or the decryption may be or include a public-key base encryption/decryption, and/or be or include a private-key based encryption/decryption; example embodiments are not limited thereto.

In a seventh operation \textcircled{7}, the storage device 200 may perform the data integrity verification for the write data WD1 to WDn of the first chunk CHK1. For example, the storage integrity manager 211 may perform the data integrity verification based on whether the verification hash data VHA are the same as the host hash data HHA obtained from the signature data SIG. When the verification hash data VHA are the same as the host hash data HHA, the storage integrity manager 211 may determine that the data integrity verification for the write data WD1 to WDn of the first chunk CHK1 succeeds (e.g., that the data integrity of the write data WD1 to WDn is secured).

When the data integrity verification for the plurality of write data WD1 to WDn succeeds, in an eighth operation \textcircled{8}, the storage device 200 may store the write data WD1 to WDn of the first chunk CHK1 in the non-volatile memory device 220.

Referring to the example of FIG. 3, as described above, the host device 100 may generate the host hash data HHA by applying the hash function to all the write data WD1 to WDn included in the first chunk CHK1 once. Meanwhile, the storage device 200 may generate the verification hash data VHA corresponding to the host hash data HHA by applying the hash function to all the write data WD1 to WDn of the first chunk CHK1 received from the host device 100 once. Accordingly, the storage device 200 may generate the verification hash data VHA only when all the write data WD1 to WDn included in the first chunk CHK1 are stored in the buffer memory 212. This indicates that the storage capacity of the buffer memory 212 should be larger than the data size of the first chunk CHK1. In this case, costs necessary to manufacture the storage device 200 may increase.

Alternatively or additionally, after the data integrity verification for the plurality of write data WD1 to WDn is completed, the storage device 200 may store the plurality of write data WD1 to WDn in the non-volatile memory device 220. In this case, the data integrity verification and the write operation related to the plurality of write data WD1 to WDn may cause the increase in latency.

According to some example embodiments however, the storage system 10 may perform the data integrity verification for the write data WD1 to WDn of the first chunk CHK1 based on an integrity hash map IMH. In this case, the storage system 10 may store the integrity hash map IMH whose size is smaller than the data size of the first chunk CHK1 in the buffer memory 212, without storing all the write data WD1 to WDn of the first chunk CHK1 in the buffer memory 212. Accordingly, the storage capacity of the buffer memory 212 may be smaller than the data size of the first chunk CHK1.

Alternatively or additionally, the storage system 10 may perform the data integrity verification and the write operation for the plurality of write data WD1 to WDn in parallel. This may indicate that the latency caused due to the data integrity verification and the write operation related to the plurality of write data WD1 to WDn decreases.

Accordingly, according to some example embodiments, a storage device with improved performance, a storage system including the storage device, and an operation method thereof are provided. A storage system according to some example embodiments will be described in detail with reference to the following drawings.

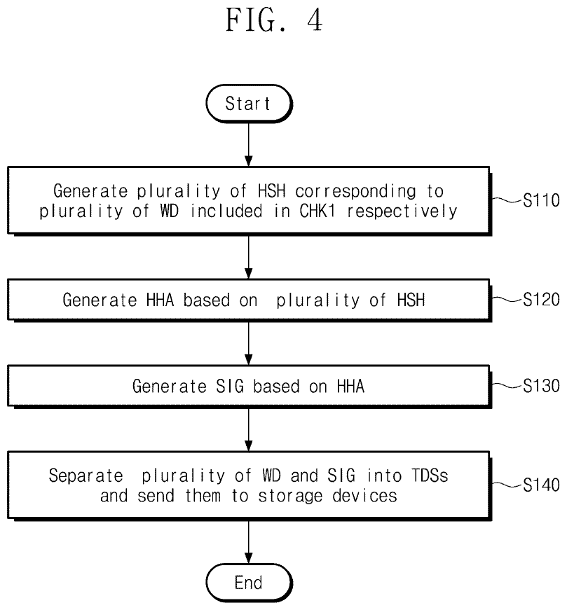

FIG. 4 is a flowchart for describing an operation method of a host device of FIG. 1. Referring to FIGS. 1, 2, and 4, in operation S110, the host device 100 may generate a plurality of host sub-hash data HSH respectively corresponding to a plurality of write data (e.g., WD1 to WDn) included in the first chunk CHK1.

In operation S120, the host device 100 may generate the host hash data HHA based on the plurality of host sub-hash data HSH.

In operation S130, the host device 100 may generate the signature data SIG based on the host hash data HHA. The host device 100 may encrypt the host hash data HHA to generate the signature data SIG; the encryption may be or may include a public-key encryption and/or a private-key encryption. Example embodiments are not limited thereto.

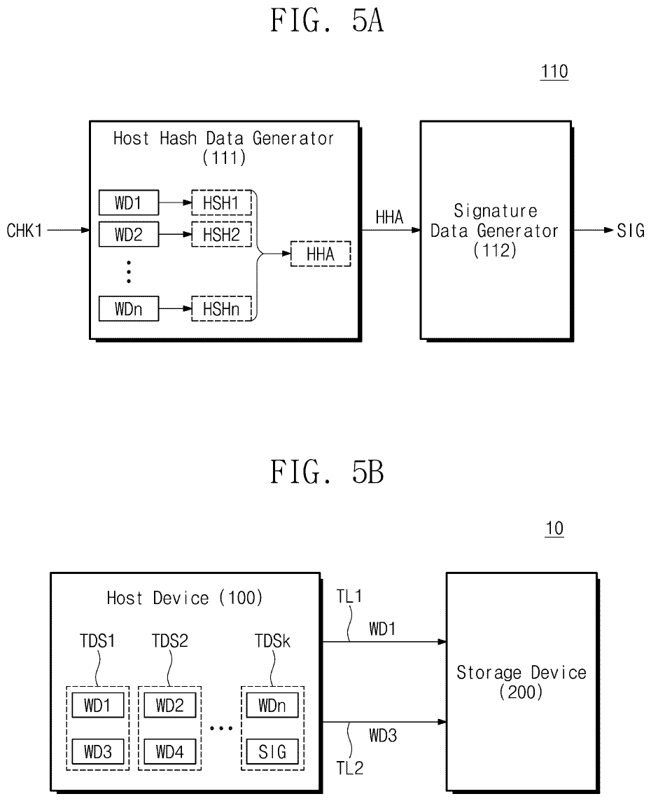

Operation S110 to operation S130 will be described in detail with reference to FIG. 5A.

In operation S140, the host device 100 may separate the signature data SIG and the plurality of write data (e.g., WD1 to WDn) corresponding to the first chunk CHK1 into a plurality of transmission data sets TDS so as to be sent to the storage device 200. In some example embodiments, the host device 100 may send the signature data SIG and the plurality of write data (e.g., WD1 to WDn) to the storage device 200 in an out-of-order manner. Operation S140 will be described in detail with reference to FIG. 5B.

FIG. 5A is a diagram for describing operation S110 to operation S130 of FIG. 4, and FIG. 5B is a diagram for describing operation S140 of FIG. 4. Referring to FIGS. 1 and 5A, the host integrity manager 110 may include a host hash data generator 111 and a signature data generator 112.

The host hash data generator 111 may receive the first chunk CHK1 including the plurality of write data WD1 to WDn. The host hash data generator 111 may generate a plurality of host sub-hash data HSH1 to HSHn respectively corresponding to the plurality of write data WD1 to WDn.

In detail, the host hash data generator 111 may apply the hash function to each of the plurality of write data WD1 to WDn to generate the plurality of host sub-hash data HSH1 to HSHn. For example, the host hash data generator 111 may apply the hash function to the first write data WD1 to generate the first host sub-hash data HSH1, may apply the hash function to the second write data WD2 to generate the second host sub-hash data HSH2, and may apply the hash function to the n-th write data WDn to generate the n-th host sub-hash data HSHn.

The host hash data generator 111 may generate the host hash data HHA based on the plurality of host sub-hash data HSH1 to HSHn. In detail, the host hash data generator 111 may apply the hash function to the plurality of host sub-hash data HSH1 to HSHn to generate the host hash data HHA.

The hash function refers to a function of mapping data of an arbitrary length to data of a fixed length. The host hash data generator 111 may apply the hash function to specific write data to generate hash data of a fixed length. For example, the host hash data generator 111 may use one or more of various hash functions including an MD5 (Message-Digest algorithm 5) and/or SHA (Secure Hash Algorithm) series. The hash function may be or may include a cryptographic hash function; however, example embodiments are not limited thereto.

The signature data generator 112 may generate the signature data SIG corresponding to the first chunk CHK1 based on the host hash data HHA. The signature data generator 112 may encrypt the host hash data HHA with the signature key to generate the signature data SIG. The encryption may be or may include a public-key cryptographic encryption and/or a private-key cryptographic encryption; example embodiments are not limited thereto

For example, the signature data SIG may refer to information used to check the integrity of the write data WD1 to WDn and may include a cyclic redundancy check (CRC) code, a checksum code, an error detection code (EDC), an error correction code (ECC), etc.

As described above, according to some example embodiments, unlike the example of FIG. 3, the host integrity manager 110 may apply the hash function to each of the plurality of write data WD1 to WDn to generate the plurality of host sub-hash data HSH1 to HSHn, and may apply the hash function to the plurality of host sub-hash data HSH1 to HSHn to generate the host hash data HHA.

Referring to FIGS. 1 and 5B, the host device 100 may separate the plurality of write data WD1 to WDn included in the first chunk CHK1 and the signature data SIG into transmission data sets TDS1 to TDSk. For example, the first transmission data set TDS1 may include the first write data WD1 and the third write data WD3, the second transmission data set TDS2 may include the second write data WD2 and the fourth write data WD4, and the k-th transmission data set TDSk may include the n-th write data WDn and the signature data SIG. The host device 100 may send the transmission data sets TDS1 to TDSk to the storage device 200 through transmission lines TL1 and TL2.

For example, the host device 100 may send the first transmission data set TDS1 to the storage device 200. In this case, the host device 100 may send the first write data WD1 through the first transmission line TL1 and may send the third write data WD3 through the second transmission line TL2.

For example, the host device 100 may send the first transmission data set TDS1 to the storage device 200 and may then send the second transmission data set TDS2 to the storage device 200. In this case, the third write data WD3 may be sent to the storage device 200 prior to the second write data WD2. Accordingly, the host device 100 may send the plurality of write data WD1 to WDn (included in the first chunk CHK1) and the signature data SIG to the storage device 200 in the out-of-order manner.

For example, unlike the example illustrated in FIG. 5B, the host device 100 may send the plurality of write data WD1 to WDn to the storage device 200 in a sequential manner. In this case, the host device 100 should send the plurality of write data WD1 to WDn through only one transmission line (e.g., TL1). This may indicate that the performance of the storage system 10 is reduced.

The first transmission line TL1 and the second transmission line TL2 may be included in a circuit (e.g., the host interface circuit 218 of FIG. 2) for providing an interface between the host device 100 and the storage device 200. An example in which the transmission data set TDS including two write data is sent through two transmission lines (e.g., TL1 and TL2) is illustrated in FIG. 5B, but example embodiments are not limited thereto. For example, the number of transmission lines and/or the number of write data included in the transmission data set TDS may be variously changed depending on a way to implement.

FIG. 6A is a flowchart for describing an operation method of a storage device of FIG. 1, and FIG. 6B is a diagram for describing an operation of a storage device of FIG. 1. Referring to FIGS. 1, 2, and 5A to 6A, in operation S210, the storage device 200 may receive the transmission data set TDS related to the first chunk CHK1 from the host device 100. For example, the transmission data set TDS may be one of the transmission data sets TDS1 to TDSk related to the first chunk CHK1.

In operation S220, the storage device 200 may store a plurality of write data WD included in the transmission data set TDS received from the host device 100 to the non-volatile memory device 220. For example, the storage device 200 may store the first write data WD1 and the third write data WD3 included in the first transmission data set TDS1 received from the host device 100 in the non-volatile memory device 220.

In operation S230, the storage device 200 may generate the integrity hash map IHM based on the plurality of write data WD included in the transmission data set TDS received from the host device 100.

In operation S240, the storage device 200 may perform data integrity verification based on the completed integrity hash map IHM.

In some example embodiments, the operation of storing the write data in the non-volatile memory device 220 (S220) may be performed in parallel with or at least partly in parallel with the operation of generating the integrity hash map IHM (S230) and the operation of performing the data integrity verification (S240).

Referring to FIGS. 1, 2, and 5A to 6B, at a first time point t1, the storage device 200 may receive the first transmission data set TDS1 from the host device 100. The first transmission data set TDS1 may include the first write data WD1 and the third write data WD3.

The storage device 200 may identify the plurality of write data (e.g., WD1 to WDn) based on logical addresses (e.g., logical block addresses (LBAs)) respectively corresponding to the plurality of write data (e.g., WD1 to WDn) included in the received transmission data set (e.g., TDS1). For example, the storage device 200 may identify that the plurality of write data included in the received transmission data set (e.g., TDS1) are the first write data WD1 and the third write data WD3, based on the logical addresses corresponding to the plurality of write data.

The storage device 200 may generate first verification sub-hash data VSH1 and third verification sub-hash data VSH3 based on the first write data WD1 and the third write data WD3 and may update the integrity hash map IHM. In some examples, the storage device 200 may store the first write data WD1 and the third write data WD3 in the non-volatile memory device 220.

In some example embodiments, the integrity hash map IHM may include a data index DATA # corresponding to the write data WD1 to WDn included in the first chunk CHK1, status information Status indicating whether a verification sub-hash corresponding to the write data WD1 to WDn is generated, and the verification sub-hash data VSH respectively corresponding to the write data WD1 to WDn.

The storage integrity manager 211 may apply the hash function to the first write data WD1 to generate the first verification sub-hash data VSH1. The storage integrity manager 211 may apply the hash function to the third write data WD3 to generate the third verification sub-hash data VSH3.

The storage integrity manager 211 may update the integrity hash map IHM by changing the status information of data index “1” of the integrity hash map IHM, which corresponds to the first write data WD1, to a valid state and storing the first verification sub-hash data VSH1 in the integrity hash map IHM. In some example embodiments, the storage integrity manager 211 may update the integrity hash map IHM by changing the status information of data index “3” of the integrity hash map IHM, which corresponds to the third write data WD3, to a valid state and storing the third verification sub-hash data VSH3 in the integrity hash map IHM.

In some example embodiments, the valid state may indicate a state where verification sub-hash data corresponding to a data index is generated.

In some example embodiments, the hash function used to generate verification sub-hash data (e.g., VSH1) may be the same as the hash function used to generate the host sub-hash data (e.g., HSH1) of FIG. 5A; in some example embodiments, the hash functions may be seeded and/or salted with the same and/or different information.

Meanwhile, regardless of whether the integrity hash map IHM is completely updated by the storage integrity manager 211 based on the first write data WD1 and the third write data WD3, the data manager 213 may store the first write data WD1 and the third write data WD3 in the non-volatile memory device 220.

In some example embodiments, the data manager 213 may store the first write data WD1 and the third write data WD3 in the buffer memory 212 (e.g., a write buffer (not illustrated) included in the buffer memory 212) and may delete the first write data WD1 and the third write data WD3 from the buffer memory 212 (e.g., the write buffer (not illustrated) included in the buffer memory 212) after the update of the integrity hash map IHM corresponding to the first write data WD1 and the third write data WD3 is completed.

In some example embodiments, the operation in which the data manager 213 stores the write data WD1 and WD3 of the first transmission data set TDS1 in the non-volatile memory device 220 may be performed in parallel with the operation in which the storage integrity manager 211 generates the plurality of verification sub-hash data VSH1 and VSH3 and updates the integrity hash map IHM.

At a second time point t2 following the first time point t1, the storage device 200 may receive the second transmission data set TDS2 sent from the host device 100. The second transmission data set TDS2 may include the second write data WD2 and the fourth write data WD4. The storage device 200 may generate second verification sub-hash data VSH2 and fourth verification sub-hash data VSH4 based on the second write data WD2 and the fourth write data WD4 and may update the integrity hash map IHM. In some example embodiments, the storage device 200 may store the second write data WD2 and the fourth write data WD4 in the non-volatile memory device 220.

The storage integrity manager 211 may apply the hash function to the second write data WD2 to generate the second verification sub-hash data VSH2. The storage integrity manager 211 may apply the hash function to the fourth write data WD4 to generate the fourth verification sub-hash data VSH4.

The storage integrity manager 211 may update the integrity hash map IHM by changing the status information of data index “2” of the integrity hash map IHM, which corresponds to the second write data WD2, to a valid state and storing the second verification sub-hash data VSH2 in the integrity hash map IHM. In some example embodiments, the storage integrity manager 211 may update the integrity hash map IHM by changing the status information of data index “4” of the integrity hash map IHM, which corresponds to the fourth write data WD4, to a valid state and storing the fourth verification sub-hash data VSH4 in the integrity hash map IHM.

Meanwhile, regardless of whether the integrity hash map IHM is completely updated by the storage integrity manager 211 based on the second write data WD2 and the fourth write data WD4, the data manager 213 may store the second write data WD2 and the fourth write data WD4 in the non-volatile memory device 220.

In some example embodiments, the data manager 213 may store the second write data WD2 and the fourth write data WD4 in the non-volatile memory device 220 and the buffer memory 212 (e.g., the write buffer (not illustrated) included in the buffer memory 212) and may delete the second write data WD2 and the fourth write data WD4 from the buffer memory 212 (e.g., the write buffer (not illustrated) included in the buffer memory 212) after the update of the integrity hash map IHM corresponding to the second write data WD2 and the fourth write data WD4 is completed.

In some example embodiments, the operation in which the data manager 213 stores the write data WD2 and WD4 of the second transmission data set TDS2 in the non-volatile memory device 220 may be performed in parallel with or at least partly in parallel with the operation in which the storage integrity manager 211 generates the plurality of verification sub-hash data VSH2 and VSH4 and updates the integrity hash map IHM.

At a third time point t3 following the second time point t2, the storage device 200 may receive the k-th transmission data set TDSk sent from the host device 100. The k-th transmission data set TDSk may include the n-th write data WDn and the signature data SIG. The storage device 200 may generate the n-th verification sub-hash data VSHn based on the n-th write data WDn and may update the integrity hash map IHM.

The storage integrity manager 211 may apply the hash function to the n-th write data WDn to generate the n-th verification sub-hash data VSHn. The storage integrity manager 211 may update the integrity hash map IHM by changing the status information of data index “n” of the integrity hash map IHM, which corresponds to the n-th write data WDn, to a valid state and storing the n-th verification sub-hash data VSHn in the integrity hash map IHM. According to the above description, in the integrity hash map IHM, the pieces of status information corresponding to all the data indexes 1 to n may be set to the valid state.

Meanwhile, regardless of whether the update of the integrity hash map IHM is completed by the storage integrity manager 211, the data manager 213 may store the n-th write data WDn in the non-volatile memory device 220. According to the above description, all the write data WD1 to WDn included in the first chunk CHK1 may be stored in the non-volatile memory device 220. Also, the data manager 213 may store the signature data SIG in the buffer memory 212.

Meanwhile, the data manager 213 may store the n-th write data WDn in the non-volatile memory device 220 and the buffer memory 212 (e.g., the write buffer (not illustrated) included in the buffer memory 212) and may delete the n-th write data WDn from the buffer memory 212 (e.g., the write buffer (not illustrated) included in the buffer memory 212) after the update of the integrity hash map IHM corresponding to the n-th write data WDn is completed.

In some example embodiments, the operation in which the data manager 213 stores the write data (e.g., WDn) in the non-volatile memory device 220 may be performed in parallel with or at least partly in parallel with the operation in which the storage integrity manager 211 generates verification sub-hash data (e.g., VSHn) and updates the integrity hash map IHM.

At a fourth time point t4 following the third time point t3, the storage device 200 may check whether the integrity hash map IHM corresponding to the first chunk CHK1 is completed. When the integrity hash map IHM is completed, the storage device 200 may generate the verification hash data VHA based on the integrity hash map IHM and may obtain the host hash data HHA based on the signature data SIG. The storage device 200 may perform data integrity verification for the write data WD1 to WDn of the first chunk CHK1 based on the verification hash data VHA and the host hash data HHA.

In some example embodiments, the number of data indexes 1 to n of the integrity hash map IHM, denoted as “n”, may be equal to the number of write data WD1 to WDn included in the first chunk CHK1, denoted as “n”, For example, all the verification sub-hash data VSH1 to VSHn corresponding to the write data WD1 to WDn may be stored in the integrity hash map IHM. In this case, the pieces of status information corresponding to all the data indexes 1 to n of the integrity hash map IHM may be set to the valid state. Accordingly, as the pieces of status information corresponding to all the data indexes 1 to n of the integrity hash map IHM are checked as the valid state, the storage integrity manager 211 may determine that the integrity hash map IHM is completed.

For example, in some example embodiments, when all the verification sub-hash data VSH1 to VSHn corresponding to the write data WD1 to WDn of the first chunk CHK1 are stored in the integrity hash map IHM, the storage integrity manager 211 may determine that the integrity hash map IHM is completed.

The storage integrity manager 211 may apply the hash function to the plurality of verification sub-hash data VSH1 to VSHn stored in the integrity hash map IHM to generate the verification hash data VHA. In some example embodiments, the hash function used to generate the verification hash data VHA may be the same as the hash function used to generate the host hash data HHA in FIG. 5A.

The storage integrity manager 211 may decrypt the signature data SIG to obtain the host hash data HHA. For example, the storage integrity manager 211 may decrypt the signature data SIG based on the signature key and may obtain the host hash data HHA.

In some example embodiments, the host device 100 and the storage device 200 may share the signature key, which is used to generate the signature data SIG (i.e., to encrypt the host hash data HHA) or to decrypt the signature data SIG (i.e., to obtain the host hash data HHA).

The storage integrity manager 211 may perform data integrity checking or verification for the write data WD1 to WDn of the first chunk CHK1. For example, the storage integrity manager 211 may perform the data integrity verification based on whether the verification hash data VHA are the same as the host hash data HHA obtained from the signature data SIG.

When the verification hash data VHA are the same as the host hash data HHA, the storage integrity manager 211 may determine that the data integrity verification for the write data WD1 to WDn of the first chunk CHK1 succeeds (i.e., that the data integrity of the plurality of write data WD1 to WDn is secured). When the verification hash data VHA are different from the host hash data HHA, the storage integrity manager 211 may determine that the data integrity verification for the write data WD1 to WDn of the first chunk CHK1 is failed (e.g., that the data integrity of the write data WD1 to WDn is not secured).

In some example embodiments, after the fourth time point t4, the storage device 200 may delete the signature data SIG corresponding to the first chunk CHK1 from the buffer memory 212. In some example embodiments, the storage device 200 may reset the integrity hash map IHM corresponding to the first chunk CHK1. For example, the storage integrity manager 211 may change pieces of status information corresponding to the data indexes 1 to n to an invalid state in the integrity hash map IHM. In some example embodiments, the storage integrity manager 211 may delete the plurality of verification sub-hash data VSH1 to VSHn which correspond to the write data WD1 to WDn of the first chunk CHK1 and are stored in the integrity hash map IHM.

Meanwhile, the hash function refers to a function of mapping data of an arbitrary length to data of a fixed length. The storage integrity manager 211 may apply the hash function to specific write data to generate hash data of a fixed length. For example, the storage integrity manager 211 may use various hash functions including an MD5 (Message-Digest algorithm 5) and/or SHA (Secure Hash Algorithm) series.

As described above, according to some example embodiments, the storage device 200 may perform data integrity checking or data integrity verification on the plurality of write data WD1 to WDn based on the integrity hash map IHM. Accordingly, for the data integrity verification, the storage device 200 may store the integrity hash map IHM, the signature data SIG, and write data included in a currently received transmission data set (e.g., only the write data WD1 and WD3 when a current time point is the first time point t1) in the buffer memory 212.

For example, the storage capacity of the buffer memory 212 necessary for or used for the data integrity verification according to some example embodiments may be smaller than the sum of data sizes of the plurality of write data WD1 to WDn (e.g., the data size of the first chunk CHK1). According to the above descriptions, the storage capacity of the buffer memory 212 may be smaller than the sum of the data sizes of the plurality of write data WD1 to WDn (e.g., the data size of the first chunk CHK1). For example, according to some example embodiments, the storage device 200 including the buffer memory 212 whose capacity is smaller than that in the example of FIG. 3 may be implemented. Accordingly, according to some example embodiments, compared to the example of FIG. 3, manufacturing costs of the storage device 200 may decrease.

Also, according to some example embodiments, the storage device 200 may perform the operation of updating the integrity hash map IHM and the operation of storing the write data WD1 to WDn in the non-volatile memory device 220 in parallel. For example, the storage device 200 may store the write data WD1 to WDn in the non-volatile memory device 220 without waiting for the completion of the data integrity verification for the write data WD1 to WDn of the first chunk CHK1. This may mean that the latency caused due to the data integrity verification and the write indicate related to the write data WD1 to WDn decreases compared to the example of FIG. 3.

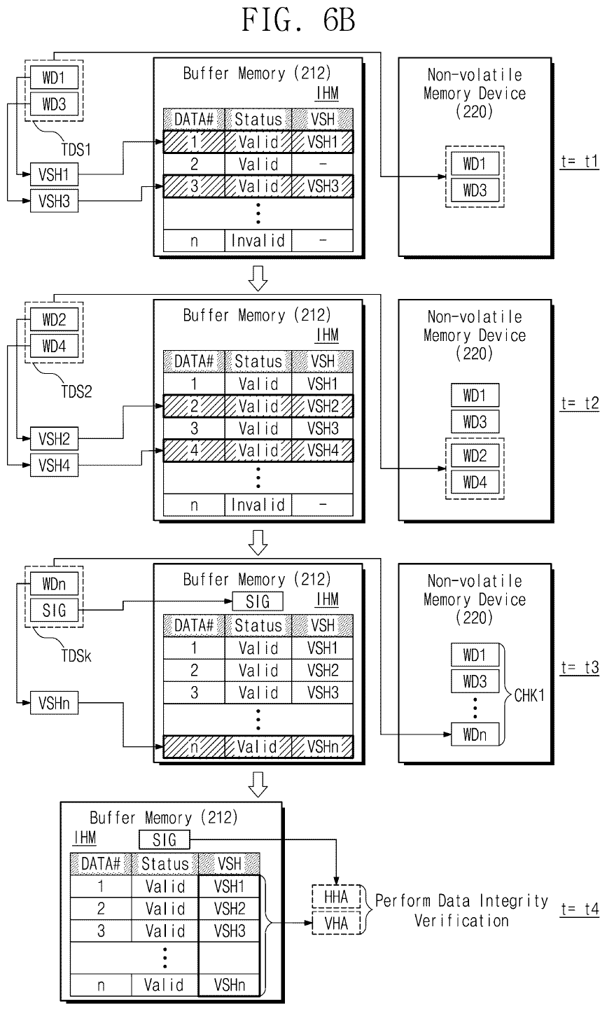

FIG. 7 is a flowchart for describing operation S220 of FIG. 6A in detail. Referring to FIGS. 1 and 6A to 7, in operation S221, the storage device 200 may store the plurality of write data WD included in the transmission data set TDS in the memory cell array of the non-volatile memory device 220. For example, the data manager 213 may store the write data WD1 and WD3 included in the first transmission data set TDS1 received from the host device 100 in the memory cell array.

In operation S222, the storage device 200 may send a storage completion signal corresponding to the received transmission data set TDS to the host device 100. For example, the data manager 213 may send, to the host device 100, the storage completion signal indicating that the write data (e.g., WD1 and WD3) included in the first transmission data set TDS1 are stored in the non-volatile memory device 220.

In operation S223, the storage device 200 may determine whether all the write data WD included in the first chunk CHK1 are received from the host device 100. For example, the data manager 213 may check whether all the write data WD1 to WDn included in the first chunk CHK1 are received from the host device 100. For example, all the write data WD1 to WDn included in the first chunk CHK1 may not be received from the host device 100. In this case, the storage device 200 may proceed to operation S210 of FIG. 6A (refer to “A” in FIG. 7). For example, in operation S210 of FIG. 6A, the storage device 200 may receive the second transmission data set TDS2 from the host device 100.

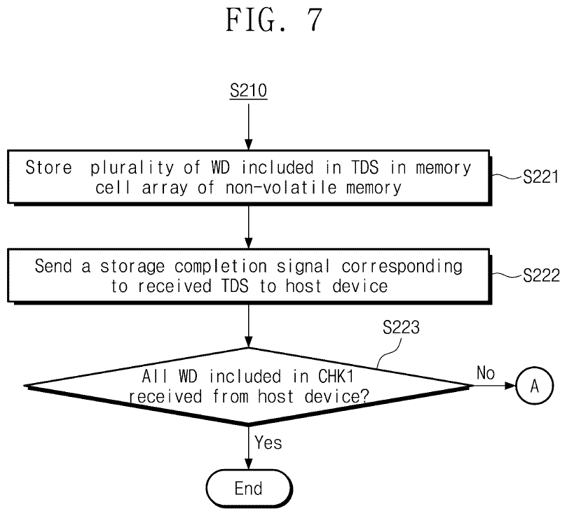

FIG. 8 is a flowchart for describing operation S230 of FIG. 6A in detail. Referring to FIGS. 1 and 4 to 8, in operation S231, the storage device 200 may generate a plurality of verification sub-hash data VSH respectively corresponding to the plurality of write data WD included in the transmission data set TDS from the host device 100. For example, the storage device 200 may receive the first transmission data set TDS1 including the first write data WD1 and the third write data WD3 from the host device 100. In this case, the storage integrity manager 211 may apply the hash function to the first write data WD1 to generate the first verification sub-hash data VSH1. Also, the storage integrity manager 211 may apply the hash function to the third write data WD3 to generate the third verification sub-hash data VSH3.

In operation S232, the storage device 200 may update the integrity hash map IHM. For example, the storage integrity manager 211 may update the integrity hash map IHM by storing the first verification sub-hash data VSH1 and the third verification sub-hash data VSH3 in the integrity hash map IHM and changing status information corresponding to the first write data WD1 and the third write data WD3 to a valid state.

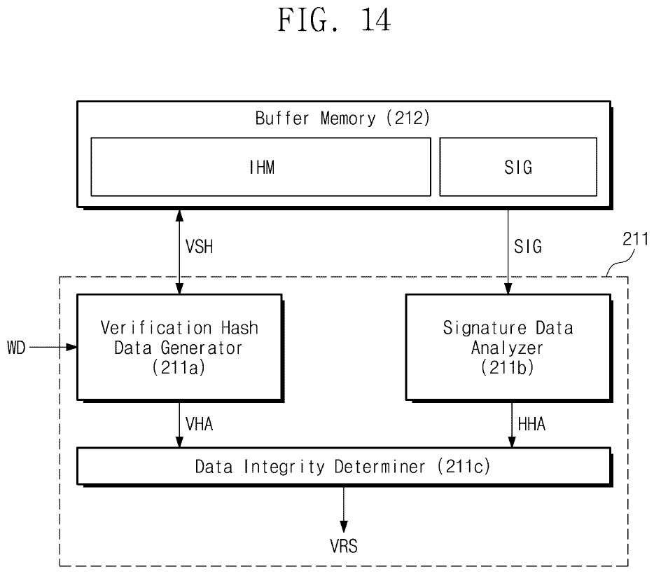

In operation S233, the storage device 200 may determine whether a power-off situation occurs. When the power-off situation occurs, the storage device 200 may proceed to operation S236 of FIG. 13 (refer to “B” in FIG. 8). When the power-off situation does not occur, the storage device 200 may perform operation S234.

In operation S234, the storage device 200 may determine whether the integrity hash map IHM corresponding to the first chunk CHK1 is completed. When the integrity hash map IHM is completed, the storage device 200 may perform operation S235. When the integrity hash map IHM is not completed, the storage device 200 may proceed to operation S210 of FIG. 6A (refer to “A” in FIG. 8). For example, in operation S210, the storage device 200 may receive the second transmission data set TDS2 from the host device 100.

For example, all the verification sub-hash data VSH1 to VSHn corresponding to the write data WD1 to WDn of the first chunk CHK1 may be stored in the integrity hash map IHM. In this case, pieces of status information respectively corresponding to all the data indexes 1 to n of the integrity hash map IHM may be set to the valid state. In this case, the storage integrity manager 211 may determine that the integrity hash map IHM is completed.

In operation S235, the storage device 200 may determine whether the signature data SIG corresponding to the first chunk CHK1 are stored in the buffer memory 212. For example, the storage integrity manager 211 may check the buffer memory 212 to determine whether the signature data SIG are stored. When the signature data SIG are stored in the buffer memory 212, the storage device 200 may perform operation S240. When there is a state where the signature data SIG are not stored in the buffer memory 212, the storage device 200 may proceed to operation S210 of FIG. 6A (refer to “A” stored in. 8). For example, in operation S210, the storage device 200 may receive the second transmission data set TDS2 from the host device 100.

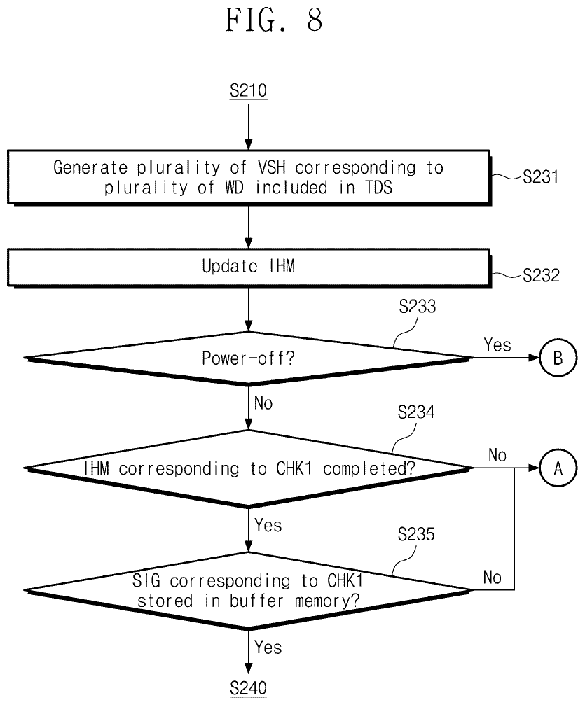

FIG. 9 is a flowchart for describing operation S240 of FIG. 6A in detail. Referring to FIGS. 1 and 4 to 9, in operation S241, the storage device 200 may generate the verification hash data VHA based on the plurality of verification sub-hash data VSH1 to VSHn included in the completed integrity hash map IHM. For example, the storage integrity manager 211 may apply the hash function to the plurality of verification sub-hash data VSH1 to VSHn to generate the verification hash data VHA.

In operation S242, the storage device 200 may obtain the host hash data HHA based on the signature data SIG. For example, the storage integrity manager 211 may decrypt the signature data SIG stored in the buffer memory 212 to obtain the host hash data HHA.

In operation S243, the storage device 200 may determine data integrity for the write data WD1 to WDn included in the first chunk CHK1 based on whether the verification hash data VHA are the same as the host hash data HHA. For example, when the verification hash data VHA are the same as the host hash data HHA, the storage integrity manager 211 may determine that the data integrity verification for the write data WD1 to WDn of the first chunk CHK1 succeeds (i.e., that the data integrity of the write data WD1 to WDn is secured).

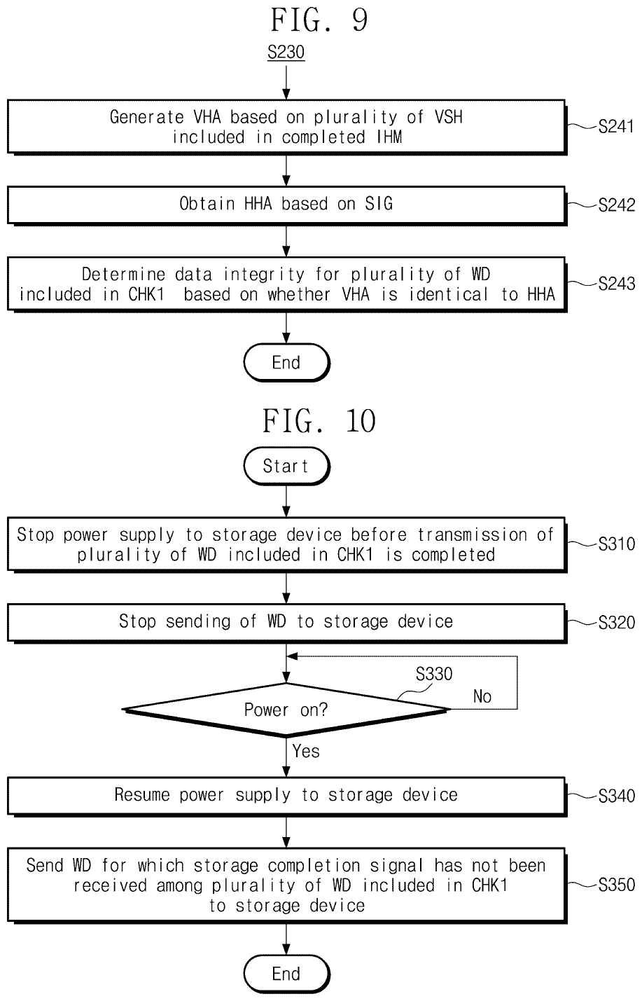

FIG. 10 is a flowchart for describing an operation method of a storage device of FIG. 1 when a power-off situation occurs. Referring to FIGS. 1 and 4 to 10, in operation S310, the host device 100 may stop the power supply to the storage device 200 before the write data WD1 to WDn of the first chunk CHK1 are completely sent to the storage device 200.

For example, when a power-off request is received from the user of the storage system 10, the host device 100 may recognize the occurrence of the power-off situation. For example, when aa sudden power off (SPO) situation occurs where the power supply to the storage device 200 is suddenly blocked, the host device 100 may recognize the occurrence of the power-off situation. The SPO may be or correspond to a blackout and/or a brownout event; however, example embodiments are not limited thereto

In operation S320, the host device 100 may stop sending the write data WD1 to WDn to the storage device 200.

In operation S330, the host device 100 may determine whether a power-on situation occurs in the storage device 200. For example, when a power-on request is received from the user of the storage system 10, the host device 100 may recognize the occurrence of the power-on situation. For example, when the sudden power-off situation of the storage device 200 is terminated, the host device 100 may recognize the occurrence of the power-on situation. When the power-on situation occurs, the host device 100 may perform operation S340.

In operation S340, the host device 100 may resume the power supply to the storage device 200.

In operation S350, the host device 100 may send write data whose storage completion signal is not received from among the plurality of write data WD1 to WDn to the storage device 200. For example, when the host device 100 receives the storage completion signal corresponding to the first transmission data set TDS1, the storage device 200 may be powered off and may then be powered on. In this case, the host device 100 may send the second transmission data set TDS2 including the second write data WD2 and the fourth write data WD4 without resending the first transmission data set TDS1 to the storage device 200.

For example, even though the power-off situation occurs in the storage device 200 while the write data WD1 to WDn included in the first chunk CHK1 are being sent, the host device 100 may not resend a plurality of write data transmitted already.

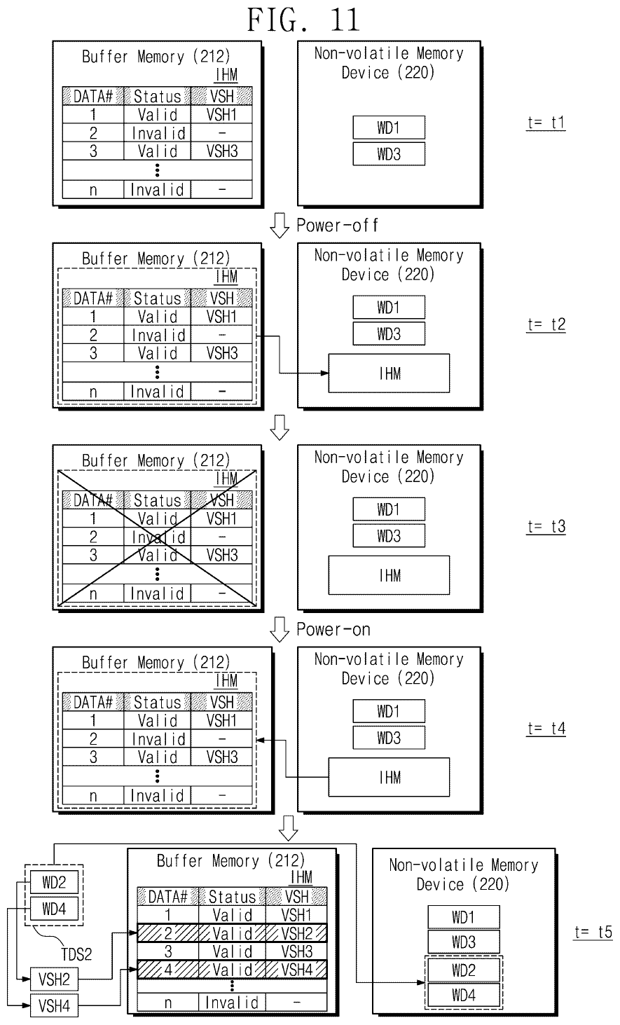

FIG. 11 is a diagram for describing an operation of a storage device of FIG. 1 when a power-off situation occurs. Referring to FIGS. 1 and 4 to 11, at the first time point t1, the storage device 200 may be in a state where the first transmission data set TDS1 including the first write data WD1 and the second write data WD2 are received. According to the above description, there may be a state where the first verification sub-hash data VSH1 and the third verification sub-hash data VSH3 are stored in the integrity hash map IHM. Also, there may be a state where the first write data WD1 and the third write data WD3 are stored in the non-volatile memory device 220. Meanwhile, a first time point t1 may be a time point after the storage device 200 sends the storage completion signal corresponding to the first transmission data set TDS1 to the host device 100.

Between the first time point t1 and the second time point t2, the power-off situation may occur in the storage device 200. In other words, the power supply from the host device 100 to the storage device 200 may be stopped.

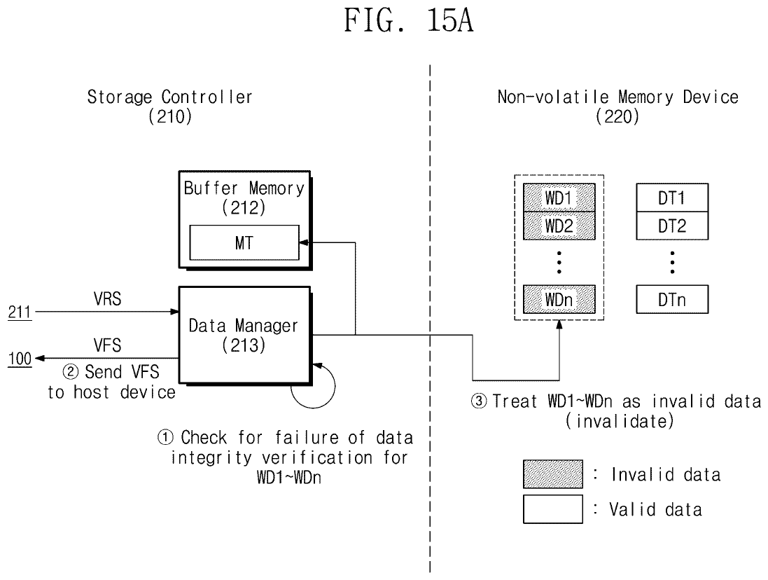

At a second time point t2, the storage integrity manager 211 may back up the integrity hash map IHM to the non-volatile memory device 220 based on an auxiliary power (e.g., AP of FIG. 14) supplied from the inside of the storage device 200.

At a third time point t3, the power supply to the buffer memory 212 may be stopped (e.g., the supply of the auxiliary power (e.g., AP of FIG. 14) may be stopped). In this case, the integrity hash map IHM of the buffer memory 212 being a volatile memory device may be deleted (or lost).

Between the third time point t3 and a fourth time point t4, the power-on situation may occur in the storage device 200. In other words, the power supply from the host device 100 to the storage device 200 may be resumed.

At the fourth time point t4, the storage integrity manager 211 may load the integrity hash map IHM backed up to the non-volatile memory device 220 to the buffer memory 212.

At a fifth time point t5, the storage device 200 may receive the second transmission data set TDS2 from the host device 100. The storage integrity manager 211 may generate the verification sub-hash data VSH2 and VSH4 based on the write data WD2 and WD4 included in the second transmission data set TDS2 and may update the integrity hash map IHM. Also, the data manager 213 may store the write data WD2 and WD4 included in the second transmission data set TDS2 in the non-volatile memory device 220.

As described above, the power-off situation may occur before the data integrity verification is completed. In this case, for example, when the storage device 200 operates like the example of FIG. 3, the write data (e.g., WD1 to WDn) stored in the buffer memory 212 may be deleted. Accordingly, after the power-on situation occurs, the storage device 200 should again receive the write data WD1 to WDn.

According to some example embodiments, as described above, when the power-off situation occurs, the storage device 200 may back up the integrity hash map IHM to the non-volatile memory device 220. This may indicate that the storage device 200 does not again receive the write data (e.g., WD1 and WD3) after the power-on situation occurs. Accordingly, when the power-off situation occurs, the latency due to the data integrity verification for the plurality of write data WD1 to WDn may decrease.

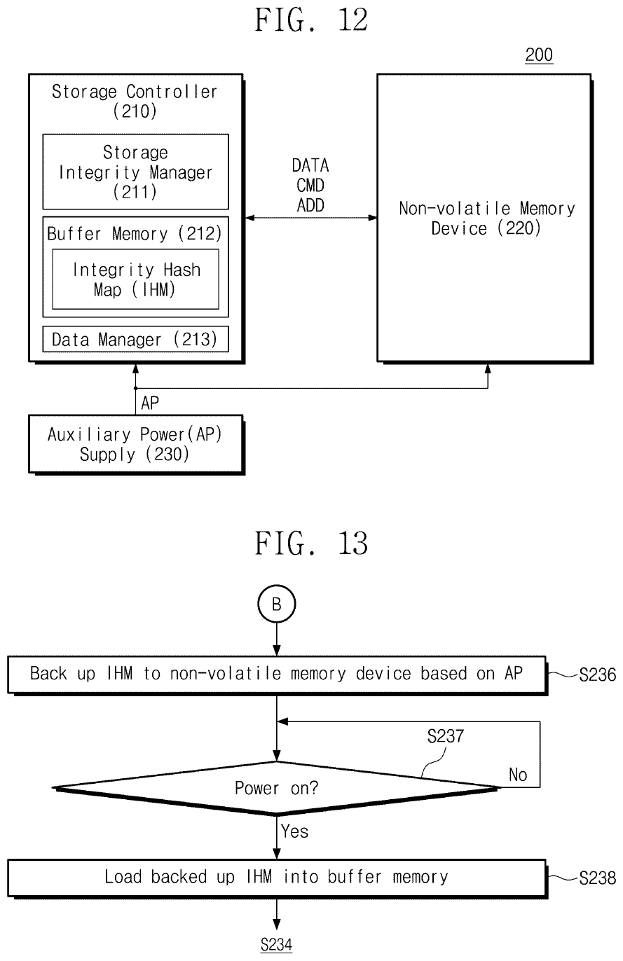

FIG. 12 is a block diagram for describing a storage device of FIG. 1 in detail. Referring to FIGS. 1 and 4 to 12, the storage device 200 may include the storage controller 210, the non-volatile memory device 220, and an auxiliary power (AP) supply 230. The storage controller 210 and the non-volatile memory device 220 respectively correspond to the storage controller 210 and the non-volatile memory device 220 of FIG. 1, and thus, additional description will be omitted to avoid redundancy.

In some example embodiments, the power supply from the host device 100 to the storage device 200 may be stopped (e.g., the power-off situation may occur in the storage device 200). When the power-off situation occurs, the auxiliary power supply 230 may generate an auxiliary power AP and may supply the auxiliary power AP to the storage controller 210 and the non-volatile memory device 220.

In some example embodiments, the auxiliary power supply 230 may include one or more capacitors for generating the auxiliary power AP. In some example embodiments, the auxiliary power supply 230 may have a structure where at least two capacitors are connected in parallel.

When the power-off situation occurs, the storage controller 210 and the non-volatile memory device 220 may operate based on the auxiliary power AP. In some example embodiments, when the power-off situation occurs, the storage integrity manager 211 may back up the integrity hash map IHM to the non-volatile memory device 220 based on the auxiliary power AP.

FIG. 13 is a flowchart for describing an operation method of a storage device of FIG. 1 when a power-off situation occurs. Referring to FIGS. 1 and 4 to 13, in operation S236, the storage device 200 may back up the integrity hash map IHM to the non-volatile memory device 220 based on the auxiliary power AP. For example, the storage integrity manager 211 may back up the integrity hash map IHM based on the auxiliary power AP generated from the auxiliary power supply 230 (refer to FIG. 13).

In operation S237, the storage device 200 may determine whether a power-on situation occurs. For example, when the power supply from the host device 100 is resumed, the storage device 200 may determine that the power-on situation occurs. When the power-on situation occurs, the storage device 200 may perform operation S238.

In operation S238, the storage device 200 may load the backed-up integrity hash map IHM to the buffer memory 212. For example, the storage integrity manager 211 may load the integrity hash map IHM backed up to the non-volatile memory device 220 to the buffer memory 212.

FIG. 14 is a block diagram for describing a storage integrity manager of FIG. 1. Referring to FIGS. 1 and 4 to 14, the storage integrity manager 211 may include a verification hash data generator 211a, a signature data analyzer 211b, and a data integrity determiner 211c.

The verification hash data generator 211a may generate the verification sub-hash data VSH, based on the write data WD. For example, the write data WD may be one of the plurality of write data WD1 to WDn of the first chunk CHK1. The verification hash data generator 211a may apply the hash function to the write data WD to generate the verification sub-hash data VSH corresponding to the write data WD. The verification hash data generator 211a may update the integrity hash map IHM by storing the verification sub-hash data VSH in the integrity hash map IHM and changing status information corresponding to the write data WD to a valid state. Also, the verification hash data generator 211a may apply the hash function to a plurality of verification sub-hash data (e.g., VSH1 to VSHn) stored in the completed integrity hash map IHM to generate the verification hash data VHA.

The signature data analyzer 211b may decrypt the signature data SIG corresponding to the first chunk CHK1 to obtain the host hash data HHA. The signature data analyzer 211b may decrypt the signature data SIG based on the signature key and may obtain the host hash data HHA. In this case, the signature key may be the same as the key used for the host device 100 to generate the signature data SIG.

The data integrity determiner 211c may perform data integrity verification for the write data WD1 to WDn of the first chunk CHK1 based on the verification hash data VHA and the host hash data HHA. In some example embodiments, the data integrity determiner 211c may generate a verification result signal VRS indicating a result of the data integrity verification for the write data WD1 to WDn of the first chunk CHK1.

For example, when the verification hash data VHA are the same as the host hash data HHA, the data integrity determiner 211c may generate the verification result signal VRS indicating the data integrity verification success. For example, when the verification hash data VHA are different from the host hash data HHA, the data integrity determiner 211c may generate the verification result signal VRS indicating the data integrity verification failure.

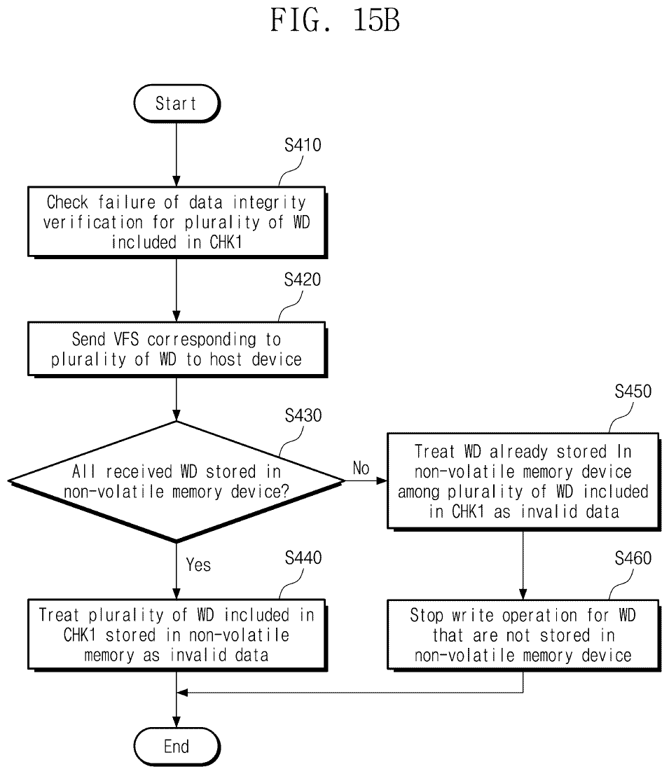

FIG. 15A is a diagram for describing an example of an operation of a storage device of FIG. 1 when data integrity verification is failed. FIG. 15B is a flowchart for describing an example of an operation method of a storage device of FIG. 1 when data integrity verification is failed. FIGS. 15A and 15B will be described with reference to FIGS. 1, 2, and 4 to 14.

Referring to FIG. 15A, in a first operation \textcircled{1}, the storage device 200 may determine whether data integrity verification for the plurality of write data WD1 to WDn included in the first chunk CHK1 is failed. In detail, the data manager 213 may receive the verification result signal VRS from the data integrity determiner 211c. For example, the verification result signal VRS may include information indicating that the data integrity verification for the plurality of write data WD1 to WDn is failed. Accordingly, the data manager 213 may check that the data integrity verification for the plurality of write data WD1 to WDn is failed.

In a second operation \textcircled{2}, the data manager 213 may send a verification failure signal VFS to the host device 100. For example, the verification failure signal VFS may refer to a signal requesting to resend the write data WD1 to WDn of the first chunk CHK1. In some example embodiments, the host device 100 may resend the write data WD1 to WDn of the first chunk CHK1 to the storage device 200 in response to the verification failure signal VFS.

In a third operation \textcircled{3}, the data manager 213 may treat the write data WD1 to WDn of the first chunk CHK1, which are stored in the non-volatile memory device 220 (e.g., the memory cell array) and experience the data integrity verification failure, as invalid data. For example, in a mapping table MT of the buffer memory 212, the data manager 213 may mark that data stored at physical addresses corresponding to the first to n-th write data WD1 to WDn are invalid data. That is, the data manager 213 may invalidate the first to n-th write data WD1 to WDn. According to the above operation, the storage device 200 may prevent the plurality of write data WD1 to WDn experiencing the data integrity verification failure from being treated as valid data.

For example, the invalid data may include data which are stored in the memory cell array but are not accessed by the deletion or update on a file system any more. For example, the invalid data may refer to data targeted for the erase operation from among a plurality of data stored in the memory cell array.

Referring to FIG. 15B, in operation S410, the storage device 200 may check that the data integrity verification for the write data WD1 to WDn included in the first chunk CHK1 is failed. In detail, the storage device 200 may check that the data integrity verification is failed, based on the verification result signal VRS.

In operation S420, the storage device 200 may send the verification failure signal VFS corresponding to the plurality of write data WD1 to WDn to the host device 100.

In operation S430, the storage device 200 may determine whether all the received write data WD1 to WDn are stored in the non-volatile memory device 220 (e.g., whether all the received write data WD1 to WDn are stored in the memory cell array of the non-volatile memory device 220). When all the write data WD1 to WDn are stored in the non-volatile memory device 220, the storage device 200 may perform operation S440. When at least some of the plurality of write data WD1 to WDn are not stored in the non-volatile memory device 220, the storage device 200 may perform operation S450.

For example, after the storage controller 210 sends write commands corresponding to the plurality of write data WD1 to WDn to the non-volatile memory device 220, the storage controller 210 may check the failure of the data integrity verification for the plurality of write data WD1 to WDn. In this case, there may be a state where the non-volatile memory device 220 fails to process all the write commands corresponding to the plurality of write data WD1 to WDn. That is, for example, there may be a state where some of the write commands received from the storage controller 210 are stored (or present) in a command queue of the non-volatile memory device 220. In other words, there may be a state where all the write data WD1 to WDn are not stored in the memory cell array of the non-volatile memory device 220. In this case, the storage device 200 may determine that all the received write data WD1 to WDn are not stored in the non-volatile memory device 220.

In operation S440, the storage device 200 may treat the plurality of write data WD1 to WDn stored in the non-volatile memory device 220 as invalid data. For example, in the mapping table MT of the buffer memory 212, the data manager 213 may mark that the plurality of data stored at the physical addresses corresponding to the plurality of write data WD1 to WDn are invalid data. That is, the data manager 213 may invalidate the plurality of write data WD1 to WDn.

In operation S450, the storage device 200 may treat the plurality of write data WD1 to WDn already stored in the non-volatile memory device 220 as invalid data. For example, there may be a state where the first to fourth write data WD1 to WD4 among the plurality of write data WD1 to WDn are stored in the memory cell array, and there may be a state where write commands corresponding to the fifth to n-th write data WD5 to WDn are stored (or present) in the command queue of the non-volatile memory device 220. In this case, in the mapping table MT of the buffer memory 212, the data manager 213, the data manager 213 may mark that the first to fourth write data WD1 to WD4 are invalid data. Also, in some example embodiments, in the mapping table MT, the data manager 213 may release the mapping between logical addresses and physical addresses corresponding to the fifth to n-th write data WD5 to WDn.

In operation S460, the storage device 200 may stop the write operation for write data not stored in the non-volatile memory device 220. For example, the storage controller 210 may send, to the non-volatile memory device 220, a write stop command for the write command corresponding to the fifth to n-th write data WD5 to WDn stored (or present) in the command queue of the non-volatile memory device 220. The non-volatile memory device 220 may not perform the write operation for the fifth to n-th write data WD5 to WDn in response to the write stop command.

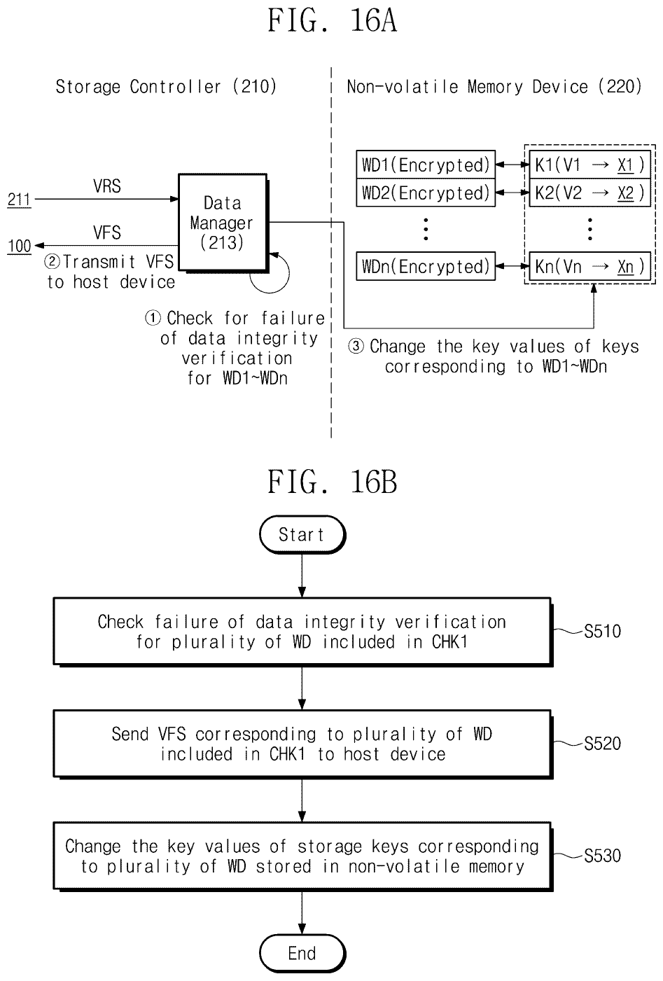

FIG. 16A is a diagram for describing another example of an operation of a storage device of FIG. 1 when data integrity verification is failed. FIG. 16B is a flowchart for describing another example of an operation method of a storage device of FIG. 1 when data integrity verification is failed. FIGS. 16A and 16B will be described with reference to FIGS. 1, 2, and 4 to 15B.

A first operation \textcircled{1} and a second operation \textcircled{2} of FIG. 16A are similar to the first operation \textcircled{1} and the second operation \textcircled{2} of FIG. 15A, and thus, additional description will be omitted to avoid redundancy.

For example, the storage device 200 may encrypt the plurality of write data WD1 to WDn received from the host device 100 based on storage keys K1 to Kn, so as to be stored in the memory cell array of the non-volatile memory device 220. For example, the storage device 200 may encrypt the first write data WD1 based on the first storage key K1 having a first encryption value V1 so as to be stored in the memory cell array, may encrypt the second write data WD2 based on the second storage key K2 having a second encryption value V2 so as to be stored in the memory cell array, and may encrypt the n-th write data WDn based on the n-th storage key Kn having an n-th encryption value Vn so as to be stored in the memory cell array. For example, the storage keys K1 to Kn may be stored in the memory cell array.

As described with reference to FIGS. 15A and 15B, when the data integrity verification for the plurality of write data WD1 to WDn is failed, the storage device 200 may treat the plurality of write data WD1 to WDn as invalid data. However, even in this case, before the erase operation for the plurality of write data WD1 to WDn is performed, the plurality of encrypted write data WD1 to WDn and the storage keys K1 to Kn stored in the memory cell array may be read from the outside. This may mean that the plurality of encrypted write data WD1 to WDn are capable of being decrypted through the storage keys K1 to Kn. As a result, the write data WD1 to WDn of the user of the storage system 10 may be leaked out to the outside.

Returning to FIG. 16A, in a third operation \textcircled{3}, the data manager 213 may change key values of the storage keys K1 to Kn corresponding to the plurality of write data WD1 to WDn experiencing the data integrity verification failure.

For example, the data manager 213 may change the key value corresponding to the first storage key K1 from the first encryption value V1 to a first invalid value X1, may change the key value corresponding to the second storage key K2 from the second encryption value V2 to a second invalid value X2, and may change the key value corresponding to the n-th storage key Kn from the n-th encryption value Vn to an n-th invalid value Xn.

According to the above description, when the plurality of encrypted write data WD1 to WDn and the storage keys K1 to Kn are read from the outside, it may be impossible to decrypt the plurality of encrypted write data WD1 to WDn based on the changed key values X1 to Xn of the storage keys K1 to Kn. Accordingly, the write data WD1 to WDn of the user of the storage system 10 may be prevented from being leaked out.

Referring to FIG. 16B, in operation S510, the storage device 200 may check that the data integrity verification for the plurality of write data WD1 to WDn included in the first chunk CHK1 is failed. In detail, the storage device 200 may check that the data integrity verification is failed, based on the verification result signal VRS.

In operation S520, the storage device 200 may send the verification failure signal VFS corresponding to the plurality of write data WD1 to WDn to the host device 100. In some example embodiments, the host device 100 may resend the write data WD1 to WDn of the first chunk CHK1 to the storage device 200 in response to the verification failure signal VFS.

In operation S530, the storage device 200 may change the key values V1 to Vn of the storage keys K1 to Kn corresponding to the plurality of write data WD1 to WDn stored in the non-volatile memory device 220. For example, the data manager 213 may change the key values V1 to Vn of the storage keys K1 to Kn to the invalid values X1 to Xn.

In some example embodiments, when the data integrity verification for the write data WD1 to WDn is failed, the storage device 200 may perform both the invalidation operation described with reference to FIGS. 15A and 15B and the key change operation described with reference to FIGS. 16A and 16B.

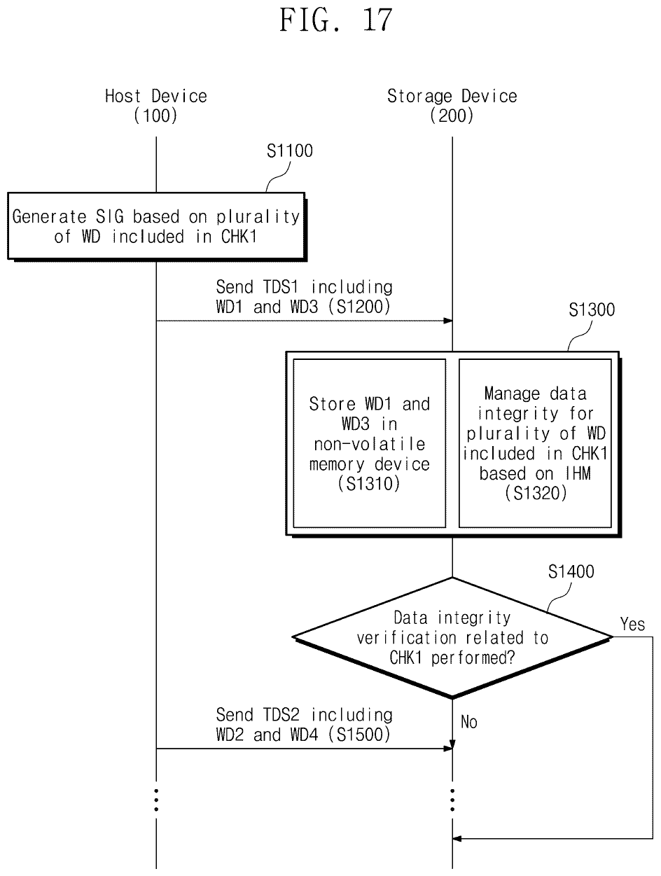

FIG. 17 is a flowchart for describing an operation of a storage system of FIG. 1. FIG. 17 will be described with reference to FIGS. 1 and 4 to 16B. Referring to FIG. 17, in operation S1100, the host device 100 may generate the signature data SIG based on the plurality of write data WD (e.g., WD1 to WDn) included in the first chunk CHK1. For example, as described with reference to FIG. 5A, the host device 100 may generate the plurality of host sub-hash data HSH1 to HSHn respectively corresponding to the plurality of write data WD1 to WDn, may generate the host hash data HHA based on the plurality of host sub-hash data HSH1 to HSHn, and may generate the signature data SIG based on the host hash data HHA.

In operation S1200, the host device 100 may send the first transmission data set TDS1 including the first write data WD1 and the third write data WD3 to the storage device 200. For example, as described with reference to FIG. 5B, the host device 100 may separate the plurality of write data WD1 to WDn into the plurality of transmission data sets TDS1 to TDSk and may then send the first transmission data set TDS1 including the first write data WD1 and the third write data WD3 to the storage device 200.

In operation S1300, the storage device 200 may process the first transmission data set TDS1.

In detail, in operation S1310, the storage device 200 may store the first write data WD1 and the third write data WD3 received from the host device 100 in the non-volatile memory device 220. For example, as described with reference to FIG. 7, the storage device 200 may store the first write data WD1 and the third write data WD3 in the memory cell array and may send the storage completion signal corresponding to the first transmission data set TDS1 to the host device 100.

In operation S1320, the storage device 200 may manage data integrity for the write data (e.g., WD1 to WDn) included in the first chunk CHK1 based on the integrity hash map IHM. For example, as described with reference to FIGS. 8 to 13, the storage device 200 may generate the first verification sub-hash data VSH1 and the third verification sub-hash data VSH3 based on the first write data WD1 and the third write data WD3. The storage device 200 may generate the integrity hash map IHM storing the first verification sub-hash data VSH1 and the third verification sub-hash data VSH3. When the integrity hash map IHM is completed, the storage device 200 may perform data integrity verification for the write data WD1 to WDn, based on the integrity hash map IHM.

In operation S1400, the storage device 200 may determine whether data integrity verification related to the first chunk CHK1 is performed. For example, when data integrity verification for the plurality of write data WD1 to WDn included in the first chunk CHK1 is performed, the storage device 200 may not receive a transmission data set corresponding to the first chunk CHK1 from the host device 100 anymore. For example, when the data integrity verification for the plurality of write data WD1 to WDn included in the first chunk CHK1 is not performed, operation S1500 may be performed.

In operation S1500, the storage device 200 may send the second transmission data set TDS2 including the second write data WD2 and the fourth write data WD4 to the storage device 200.

After operation S1500, as in the above description given in operation S1300 and operation S1400, the storage device 200 may store the received write data WD2 and WD4 in the non-volatile memory device 220 and may manage the integrity hash map IHM.

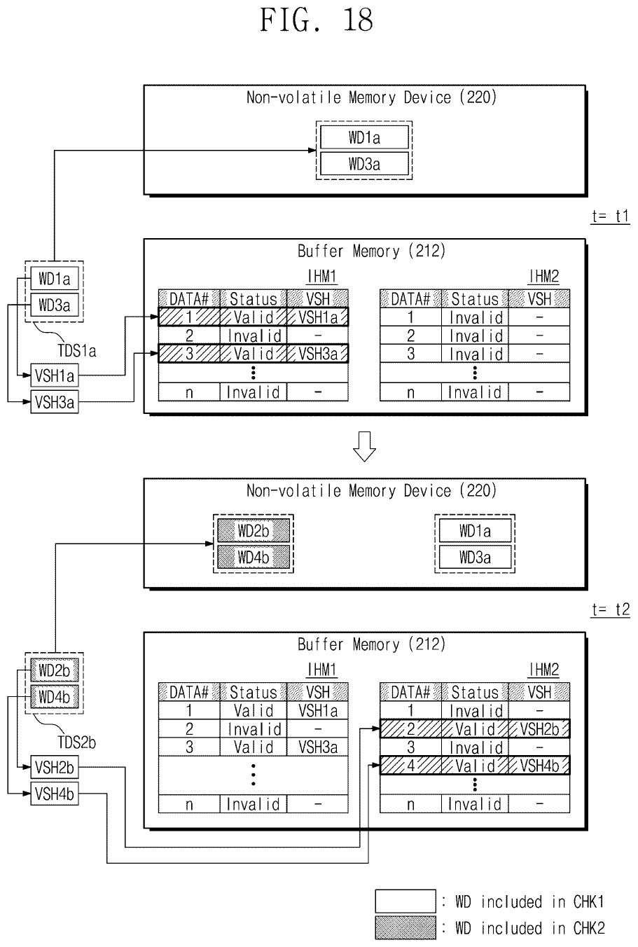

FIG. 18 is a diagram for describing an example of an operation of a storage system of FIG. 1. FIG. 18 will be described with reference to FIGS. 1 and 4 to 17. Referring to FIG. 18, unlike the description given with reference to FIG. 6B, the host device 100 may send transmission data sets corresponding to the first chunk CHK1 and transmission data sets corresponding to a second chunk CHK2 in the out-of-order manner.

In some example embodiments, the storage device 200 may generate a plurality of integrity hash maps IHM1 and IHM2 and may perform data integrity verification. For example, the storage device 200 may perform data integrity verification for write data (e.g., WD1a to WDna) of the first chunk CHK1 based on the first integrity hash map IHM1. Also, the storage device 200 may perform data integrity verification for write data (e.g., WD1b to WDnb) of the second chunk CHK2 based on the second integrity hash map IHM2.

In detail, for example, at the first time point t1, the storage device 200 may receive a first transmission data set TDS1a corresponding to the first chunk CHK1 from the host device 100. The first transmission data set TDS1a may include the first write data WD1a and the third write data WD3a of the first chunk CHK1. The storage device 200 may generate first verification sub-hash data VSH1a and third verification sub-hash data VSH3a corresponding to the first chunk CHK1 based on the first write data WD1a and the third write data WD3a. The storage device 200 may update the first integrity hash map IMH1 by storing the first verification sub-hash data VSH1a and the third verification sub-hash data VSH3a in the first integrity hash map IMH1.

At the second time point t2 following the first time point t1, the storage device 200 may receive a second transmission data set TDS2b corresponding to the second chunk CHK2 from the host device 100. That is, the storage device 200 may receive the first transmission data set TDS1a corresponding to the first chunk CHK1 prior to a second transmission data set (e.g., TDS2a) corresponding to the second chunk CHK2 from the host device 100.

The second transmission data set TDS2b may include second write data WD2b and fourth write data WD4b of the second chunk CHK2. The storage device 200 may generate second verification sub-hash data VSH2b and fourth verification sub-hash data VSH4b corresponding to the second chunk CHK2 based on the second write data WD2b and the fourth write data WD4b. The storage device 200 may update the second integrity hash map IMH2 by storing the second verification sub-hash data VSH2b and the fourth verification sub-hash data VSH4b in the second integrity hash map IMH2.

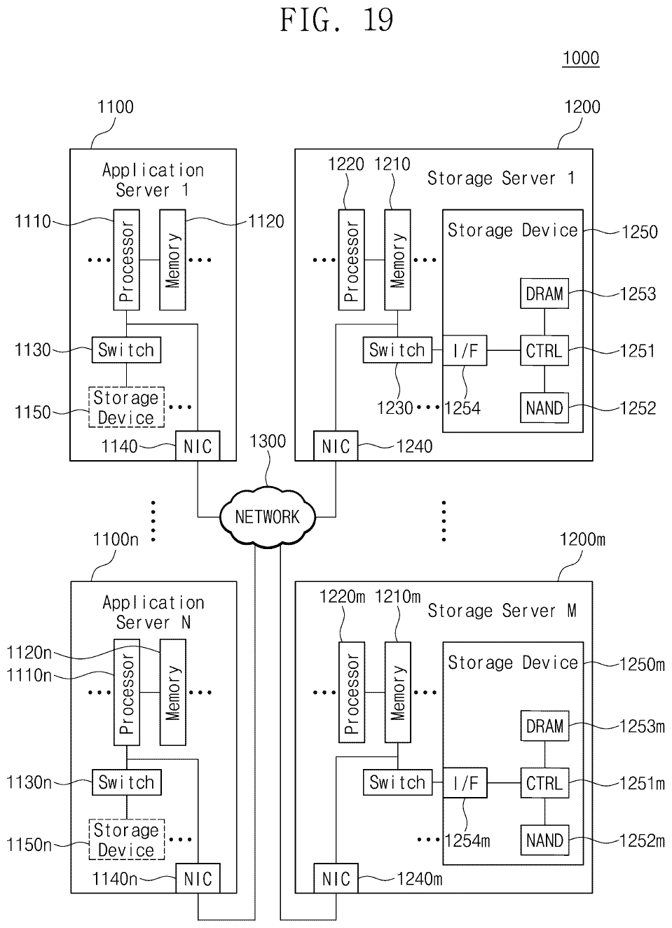

FIG. 19 is a diagram of a data center 1000 to which a memory device is applied, according to an embodiment.

Referring to FIG. 19, the data center 1000 may be a facility that collects various types of pieces of data and provides services and be referred to as a data storage center. The data center 1000 may be a system for operating a search engine and a database, and may be a computing system used by companies, such as banks, or government agencies. The data center 1000 may include application servers 1100 to 1100n and storage servers 1200 to 1200m. The number of application servers 1100 to 1100n and the number of storage servers 1200 to 1200m may be variously selected according to embodiments. The number of application servers 1100 to 1100n may be different from the number of storage servers 1200 to 1200m.

The application server 1100 or the storage server 1200 may include at least one of processors 1110 and 1210 and memories 1120 and 1220. The storage server 1200 will now be described as an example. The processor 1210 may control all operations of the storage server 1200, access the memory 1220, and execute instructions and/or data loaded in the memory 1220. The memory 1220 may be or may include one or more of a double-data-rate synchronous DRAM (DDR SDRAM), a high-bandwidth memory (HBM), a hybrid memory cube (HMC), a dual in-line memory module (DIMM), Optane DIMM, and/or a non-volatile DIMM (NVMDIMM). In some embodiments, the numbers of processors 1210 and memories 1220 included in the storage server 1200 may be variously selected. In some example embodiments, the processor 1210 and the memory 1220 may provide a processor-memory pair. In some example embodiments, the number of processors 1210 may be different from the number of memories 1220. The processor 1210 may include a single-core processor or a multi-core processor. The above description of the storage server 1200 may be similarly applied to the application server 1100. In some embodiments, the application server 1100 may not include a storage device 1150. The storage server 1200 may include at least one storage device 1250. The number of storage devices 1250 included in the storage server 1200 may be variously selected according to embodiments.

The application servers 1100 to 1100n may communicate with the storage servers 1200 to 1200m through a network 1300. The network 1300 may be implemented by using a fiber channel (FC) or Ethernet. In this case, the FC may be a medium used for relatively high-speed data transmission and use an optical switch with high performance and high availability. The storage servers 1200 to 1200m may be provided as file storages, block storages, or object storages according to an access method of the network 1300.

In some example embodiments, the network 1300 may be or may include a storage-dedicated network, such as a storage area network (SAN). For example, the SAN may be or may include an FC-SAN, which uses an FC network and is implemented according to an FC protocol (FCP). Alternatively or additionally, the SAN may be or may include an Internet protocol (IP)-SAN, which uses a transmission control protocol (TCP)/IP network and is implemented according to a SCSI over TCP/IP or Internet SCSI (iSCSI) protocol. Alternatively or additionally, the network 1300 may be a general network, such as a TCP/IP network. For example, the network 1300 may be implemented according to a protocol, such as one or more of FC over Ethernet (FCoE), network attached storage (NAS), and NVMe over Fabrics (NVMe-oF).

Hereinafter, the application server 1100 and the storage server 1200 will mainly be described. A description of the application server 1100 may be applied to another application server 1100n, and a description of the storage server 1200 may be applied to another storage server 1200m.

The application server 1100 may store data, which is requested by a user or a client to be stored, in one of the storage servers 1200 to 1200m through the network 1300. Also, the application server 1100 may obtain data, which is requested by the user or the client to be read, from one of the storage servers 1200 to 1200m through the network 1300. For example, the application server 1100 may be implemented as a web server or a database management system (DBMS).

The application server 1100 may access a memory 1120n or a storage device 1150n, which is included in another application server 1100n, through the network 1300. Alternatively, the application server 1100 may access memories 1220 to 1220m or storage devices 1250 to 1250m, which are included in the storage servers 1200 to 1200m, through the network 1300. Thus, the application server 1100 may perform various operations on data stored in application servers 1100 to 1100n and/or the storage servers 1200 to 1200m. For example, the application server 1100 may execute an instruction for moving or copying data between the application servers 1100 to 1100n and/or the storage servers 1200 to 1200m. In this case, the data may be moved from the storage devices 1250 to 1250m of the storage servers 1200 to 1200m to the memories 1120 to 1120n of the application servers 1100 to 1100n directly or through the memories 1220 to 1220m of the storage servers 1200 to 1200m. The data moved through the network 1300 may be data encrypted for security or privacy.

The storage server 1200 will now be described as an example. An interface 1254 may provide physical connection between a processor 1210 and a controller 1251 and a physical connection between a network interface card (NIC) 1240 and the controller 1251. For example, the interface 1254 may be implemented using a direct attached storage (DAS) scheme in which the storage device 1250 is directly connected with a dedicated cable. For example, the interface 1254 may be implemented by using various interface schemes, such as one or more of ATA, SATA, e-SATA, an SCSI, SAS, PCI, PCIe, NVMe, IEEE 1394, a USB interface, an SD card interface, an MMC interface, an eMMC interface, a UFS interface, an eUFS interface, and/or a CF card interface.

The storage server 1200 may further include a switch 1230 and the NIC (Network InterConnect) 1240. The switch 1230 may selectively connect the processor 1210 to the storage device 1250 or selectively connect the NIC 1240 to the storage device 1250 via the control of the processor 1210.

In some example embodiments, the NIC 1240 may include a network interface card and a network adaptor. The NIC 1240 may be connected to the network 1300 by a wired interface, a wireless interface, a Bluetooth interface, or an optical interface. The NIC 1240 may include an internal memory, a digital signal processor (DSP), and a host bus interface and be connected to the processor 1210 and/or the switch 1230 through the host bus interface. The host bus interface may be implemented as one of the above-described examples of the interface 1254. In some example embodiments, the NIC 1240 may be integrated with at least one of the processor 1210, the switch 1230, and the storage device 1250.

In the storage servers 1200 to 1200m or the application servers 1100 to 1100n, a processor may transmit a command to storage devices 1150 to 1150n and 1250 to 1250m or the memories 1120 to 1120n and 1220 to 1220m and program or read data. In this case, the data may be data of which an error is corrected by an ECC engine. The data may be data on which a data bus inversion (DBI) operation or a data masking (DM) operation is performed, and may include cyclic redundancy code (CRC) information. The data may be data encrypted for security or privacy.

Storage devices 1150 to 1150n and 1250 to 1250m may transmit a control signal and a command/address signal to NAND flash memory devices 1252 to 1252m in response to a read command received from the processor. Thus, when data is read from the NAND flash memory devices 1252 to 1252m, a read enable (RE) signal may be input as a data output control signal, and thus, the data may be output to a DQ bus. A data strobe signal DQS may be generated using the RE signal. The command and the address signal may be latched in a page buffer depending on a rising edge or falling edge of a write enable (WE) signal.

The controller 1251 may control all operations of the storage device 1250. In some example embodiments, the controller 1251 may include SRAM. The controller 1251 may write data to the NAND flash memory device 1252 in response to a write command or read data from the NAND flash memory device 1252 in response to a read command. For example, the write command and/or the read command may be provided from the processor 1210 of the storage server 1200, the processor 1210m of another storage server 1200m, or the processors 1110 and 1110n of the application servers 1100 and 1100n. DRAM 1253 may temporarily store (or buffer) data to be written to the NAND flash memory device 1252 or data read from the NAND flash memory device 1252. Also, the DRAM 1253 may store metadata. Here, the metadata may be user data or data generated by the controller 1251 to manage the NAND flash memory device 1252. The storage device 1250 may include a secure element (SE) for security or privacy.

According to some example embodiments a storage device may generate a hash map based on a plurality of write data received from a host device. The storage device may perform data integrity verification for the plurality of write data based on the hash map. In this case, the storage space of the buffer memory may decrease. Accordingly, a storage system including a host device and a storage device and providing improved performance, an operation method thereof, and an operation method of the storage device are provided.

Any of the elements and/or functional blocks disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

Any or all of the elements described with reference to the above figures may communicate with any or all other elements described with reference to the same or other above figures. For example, any element may engage in one-way and/or two-way and/or broadcast communication with any or all other elements in any of the figures, to transfer and/or exchange and/or receive information such as but not limited to data and/or commands, such as in a serial and/or parallel manner, via a bus such as a wireless and/or a wired bus (not illustrated). The information may be in encoded various formats, such as in an analog format and/or in a digital format, without being limited thereto.

While inventive concepts have been described with reference to embodiments thereof, it will be apparent to those of ordinary skill in the art that various changes and modifications may be made thereto without departing from the spirit and scope of the present disclosure as set forth in the following claims. Additionally, example embodiments are not necessarily mutually exclusive with one another. For example, some example embodiments may include one or more features described with reference to one or more figures, and may also include one or more other features described with reference to one or more other figures.

What is claimed is:

1. An operation method of a storage device, the method comprising:
receiving first and second write data from an external device, the first and second write data among a plurality of write data included in a first chunk;
generating first verification sub-hash data and second verification sub-hash data respectively corresponding to the first write data and the second write data;
updating an integrity hash map by storing the first verification sub-hash data and the second verification sub-hash data in the integrity hash map; and
performing data integrity verification for the plurality of write data, based on a completion of the integrity hash map updating,
wherein the storage device includes a buffer memory configured to store the integrity hash map and having a storage capacity smaller than a data size of the first chunk.

2. The method of claim 1, further comprising:
determining that the integrity hash map is completed in response to all of a plurality of verification sub-hash data respectively corresponding to the plurality of write data being stored in the integrity hash map.

3. The method of claim 1, further comprising:
storing signature data in the buffer memory, the signature data corresponding to the first chunk and received from the external device.

4. The method of claim 3, wherein the performing of the data integrity verification includes:
generating verification hash data, based on a plurality of verification sub-hash data stored in the completed integrity hash map;
obtaining host hash data, based on the signature data; and
determining data integrity for the plurality of write data, based on whether the verification hash data are same as the host hash data.

5. The method of claim 1, wherein
the storage device includes a non-volatile memory device, and
wherein the method further comprises:
storing the first write data and the second write data in the non-volatile memory device.

6. The method of claim 5, wherein the storing of the first write data and the second write data in the non-volatile memory device includes performing the storing of the first and second write data in the non-volatile memory device in parallel with the updating of the integrity hash map and the performing of the data integrity verification.

7. The method of claim 5, further comprising:
in response to a power supply from the external device to the storage device stopped, backing up the integrity hash map to the non-volatile memory device, the backing up by the storage device.

8. The method of claim 7, further comprising:
in response to the power supply from the external device to the storage device resuming, loading the integrity hash map backed up to the non-volatile memory device to the buffer memory, the loading by the storage device.

9. The method of claim 5, further comprising:
in response to an execution result of the data integrity verification indicating a failure of data integrity verification, sending a verification failure signal, the verification failure signal indicating a request to resend the plurality of write data to the external device.

10. The method of claim 5, further comprising:
in response to an execution result of the data integrity verification indicating a failure of data integrity verification, treating the plurality of write data stored in the non-volatile memory device as invalid data, the treating by the storage device.

11. The method of claim 5, wherein
the first write data are encrypted based on a first storage key so as to be stored in the non-volatile memory device,
the second write data are encrypted based on a second storage key so as to be stored in the non-volatile memory device, and
wherein the method further comprises:
in response to an execution result of the data integrity verification indicating a failure of data integrity verification, changing a key value of each of the first storage key and the second storage key.

12. A storage system comprising:
a host device; and
a storage device,
wherein the host device is configured to:
generate a plurality of host sub-hash data respectively corresponding to a plurality of write data included in a first chunk;
generate host hash data based on the plurality of host sub-hash data;
generate signature data based on the host hash data; and
send the plurality of write data and the signature data to the storage device, and
wherein the storage device is configured to:
generate an integrity hash map corresponding to the first chunk and based on the plurality of write data; and
perform data integrity verification for the plurality of write data based on the integrity hash map being completed and on the signature data.

13. The storage system of claim 12, wherein
the storage device includes a storage controller and a non-volatile memory device,
the storage controller includes a buffer memory configured to store the integrity hash map, and
the buffer memory has a storage capacity smaller than a data size of the first chunk.

14. The storage system of claim 13, wherein the storage controller further includes a storage integrity manager configured to:
receive first write data and second write data among the plurality of write data;
generate first verification sub-hash data corresponding to the first write data and second verification sub-hash data corresponding to the second write data; and
update the integrity hash map by storing the first verification sub-hash data and the second verification sub-hash data in the integrity hash map.

15. The storage system of claim 14, wherein the storage integrity manager is further configured to:
determine that the integrity hash map is completed, in response to all of a plurality of verification sub-hash data respectively corresponding to the plurality of write data being stored in the integrity hash map.

16. The storage system of claim 14, wherein the storage integrity manager is further configured to:
generate verification hash data, based on a plurality of verification sub-hash data stored in the completed integrity hash map;
obtain the host hash data, based on the signature data; and
perform data integrity verification for the plurality of write data, based on whether the verification hash data are the same as the host hash data.

17. The storage system of claim 14, wherein the storage controller further includes a data manager configured to:
receive the first write data and the second write data from among the plurality of write data;
store the first write data and the second write data in the non-volatile memory device; and
send a storage completion signal corresponding to the first write data and the second write data to the host device.

18. The storage system of claim 17, wherein an operation in which the data manager stores the first write data and the second write data in the non-volatile memory device is performed in parallel with an operation in which the storage integrity manager updates the integrity hash map.

19. The storage system of claim 12, wherein the host device is configured to send the plurality of write data and the signature data to the storage device in an out-of-order manner.

20. An operation method of a storage system which includes a host device and a storage device, the method comprising:
generating, by the host device, a plurality of host sub-hash data respectively corresponding to a plurality of write data included in a first chunk;
generating, by the host device, signature data based on the plurality of host sub-hash data;
sending, by the host device and to the storage device, first write data and second write data among the plurality of write data;
generating, by the storage device, first verification sub-hash data and second verification sub-hash data respectively corresponding to the first write data and the second write data;
updating, by the storage device, an integrity hash map by storing the first verification sub-hash data and the second verification sub-hash data in the integrity hash map; and
performing, by the storage device, data integrity verification for the plurality of write data, based on the integrity hash map completed,
wherein the storage device includes a buffer memory storing the integrity hash map and having a storage capacity smaller than a data size of the first chunk.
